(19) United States
(12) Patent Application Publication
(10) Pub. No.: US 2021/0241391 A1
(43) Pub. Date: Aug. 5, 2021

(54) SYSTEM AND METHOD FOR FUEL STORAGE TANK INVENTORY MANAGEMENT

(71) Applicant: EDGE PETROL LIMITED, London (GB)

(72) Inventors: Gideon Carroll, London (GB); Andrew Horton, London (GB)

(73) Assignee: EDGE PETROL LIMITED, London (GB)

(21) Appl. No.: 16/760,839

(22) PCT Filed: Nov. 1, 2018
(86) PCT No.: PCT/EP2018/079952

§ 371 Date: Apr. 30, 2020

(30) Foreign Application Priority Data
Nov. 2, 2017 (GB) 1718187.6

(51) Int. Cl. G06Q 50/06; G06Q 10/08; G06Q 30/02

(52) U.S. Cl. CPC G06Q 50/06; G06Q 30/0206; G06Q 10/087

(57) ABSTRACT

A computer implemented system for fuel storage tank inventory management at a filling station, the system comprising obtaining means arranged to obtain information regarding the predicted status of a fuel stored in a specific fuel storage tank at a filling station, the obtained information comprising time window information regarding a time window for receiving a delivery of fuel for the fuel storage tank, and a graphical user interface ‘GUI’ arranged to output the time window. The GUI is arranged to display one of a plurality of different screens in response to detection of a selection input by a user, wherein each of the plurality of different screens displays the predicted status of the fuel stored in the fuel storage tank at a respective one of a plurality of different times, and wherein the displayed status of the fuel stored in the fuel storage tank comprises the remaining length of the time window at the respective one of the plurality of different times.

The present application relates to a system and method for fuel storage tank inventory management, and in particular for fuel storage tank inventory management in vehicle filling stations.

### BACKGROUND

Vehicle filling stations maintain stored stocks of fuel, generally in underground storage tanks, for sale to customers, such as retail customers. In the operation of a filling station these fuel stocks are depleted by sales to customers, so that the filling station must be restocked with fuel from time to time by a fuel delivery. Generally these fuel deliveries are carried out by road tanker vehicles.

The fuel is typically supplied, stored and sold in a number of different grades and forms, for example petrol (also called gas or gasoline in some countries, such as the USA and Canada) and diesel fuel, and both petrol and diesel fuel may be sold in a number of different grades having different formulations. These different types and grades of fuel are stored in separate storage tanks, command different prices, and are typically sold at different rates.

It is important that the stock of stored fuel of each type and grade at a filling station is managed by arranging the timing and volume of the fuel deliveries so that there is always a stock of fuel of each type and grade available in the storage tanks of the filling station for sale and supply to customers. However, since the customers are independent of the filling station it may be difficult to accurately predict future sales and stocks of the various fuel types and grades, making management of the fuel tank inventory difficult.

It is also desirable not to maintain fuel stock levels at a filling station unnecessarily high by frequent restocking. Such frequent restocking can increase the complexity of the logistics task of carrying out the restocking and increase the number of tanker vehicles required to carry out the deliveries, in addition to increasing the environmental and financial costs of operating the tanker vehicles.

Further, once fuel has been delivered and placed in a storage tank at a filling station it is generally not acceptable, for safety reasons, logistical reasons, and to prevent contamination, to remove the fuel and deliver it to another filling station. As a result, from the perspective of the overall fuel supply chain, holding a large proportion of the available fuel at filling stations may reduce the amount of fuel available for delivery, making it harder to service sudden surges in demand for fuel at specific filling stations, and so reducing the flexibility and resilience of the overall fuel supply chain.

Further, it is also desirable not to request and attempt tanker deliveries carrying more fuel than the empty space in the filling station storage tanks available to receive the fuel. It is undesirable on environmental and cost grounds for tanker vehicles to have to travel to a filling station and return still carrying fuel. Also, this gives rise to a risk that the storage tanks may be overfilled in error, creating a safety hazard.

Accordingly, it is desirable to be able to predict future demand for fuel at a filling station so that fuel storage tank inventories can be accurately managed.

The embodiments described below are not limited to implementations which solve any or all of the disadvantages of the known approaches described above.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

The present disclosure provides a graphical user interface “GUI” indicating the amount of fuel stored in different fuel storage tanks at a filling station and the time windows for safely receiving fuel deliveries for each of the fuel storage tanks at different present and future times, whereby a user can select different ones of the times for display.

In a first aspect, the present disclosure provides a computer implemented system for fuel storage tank inventory management at a filling station, the system comprising: obtaining means arranged to obtain information regarding the predicted status of a fuel stored in a specific fuel storage tank at a filling station, the obtained information comprising time window information regarding a time window for receiving a delivery of fuel for the fuel storage tank; and a graphical user interface ‘GUI’ arranged to output the time window; wherein the GUI is arranged to display one of a plurality of different screens in response to detection of a selection input by a user, wherein each of the plurality of different screens displays the predicted status of the fuel stored in the fuel storage tank at a respective one of a plurality of different times; and wherein the displayed status of the fuel stored in the fuel storage tank comprises the remaining length of the time window at the respective one of the plurality of different times.

In a second aspect, the present disclosure provides a computer implemented system for fuel storage tank inventory management at a filling station, the system comprising: obtaining means arranged to obtain information regarding the predicted status of fuel stored in one or more fuel storage tanks, the obtained information comprising time window information regarding a time window for receiving a delivery of fuel for the fuel storage tank before the amount of fuel stored in the fuel storage tank is predicted to fall below a predetermined threshold; and display means arranged to display a time window for receiving a delivery of fuel in response to detection of a selection input by a user, wherein the time window for receiving a delivery of fuel to the fuel storage tank varies in response to the selection input by the user; and the display means being further arranged to display, in addition to said time window information, a message actuation whereby generation of a message to trigger fuel supply at a displayed time or time window can be triggered from the same display.

In a third aspect, the present disclosure provides a computer implemented method for fuel storage tank inventory management at a filling station, the method comprising: obtaining information regarding the predicted status of a fuel stored in a specific fuel storage tank at a filling station, the obtained information comprising time window information regarding a time window for receiving a delivery of fuel for the fuel storage tank; and rendering a graphical user interface ‘GUI’ arranged to output the time window; wherein the GUI is arranged to display the predicted status of the fuel stored in the fuel storage tank at a selected one of a plurality of different times in response to detection of a selection input by a user; and wherein the displayed status of the fuel stored in the fuel storage tank comprises the remaining length of the time window at the respective one of the plurality of different times.

In a fourth aspect, the present disclosure provides a computer implemented method for fuel storage tank inventory management at a filling station, the system comprising: obtaining information regarding the predicted status of fuel stored in one or more fuel storage tanks, the obtained information comprising time window information regarding a time window for receiving a delivery of fuel for the fuel storage tank before the amount of fuel stored in the fuel storage tank is predicted to fall below a predetermined threshold; and displaying a time window for receiving a delivery of fuel in response to detection of a selection input by a user, wherein the time window for receiving a delivery of fuel to the fuel storage tank varies in response to the selection input by the user; and the display means displaying, in addition to said time window information, a message actuation whereby generation of a message to trigger fuel supply at a displayed time or time window can be triggered from the same display.

In a fifth aspect, the present disclosure provides a computer program comprising a plurality of computer readable instructions arranged such that, when executed on a processor of a computer they cause the computer to carry out the method according to said third aspect or said fourth aspect.

In a further aspect, the present disclosure provides a computer implemented system for fuel storage tank inventory management at a filling station, the system comprising: obtaining means arranged to obtain information regarding the predicted status of a fuel stored in a specific fuel storage tank at a filling station, the obtained information comprising time window information regarding a time window for receiving a delivery of fuel for the fuel storage tank; and a graphical user interface ‘GUI’ arranged to output the time window; wherein the GUI is arranged to display one of a plurality of different screens in response to detection of a selection input by a user, wherein each of the plurality of different screens displays the predicted status of the fuel stored in the fuel storage tank at a respective one of a plurality of different times; wherein the displayed status of the fuel stored in the fuel storage tank comprises the remaining length of the time window at the respective one of the plurality of different times; wherein each of the different screens comprises a time selection input means allowing a user to select which one of the plurality of different times is displayed by the GUI; and wherein each of the different screens comprises an order input means, wherein the system response to selection of the order input means by generating a fuel order for a delivery of fuel, wherein the fuel order requests a delivery of fuel at the one of the plurality of different times corresponding to the screen being displayed by the GUI.

The methods described herein may be performed by software in machine readable form on a tangible storage medium e.g. in the form of a computer program comprising computer program code means adapted to perform all the steps of any of the methods described herein when the program is run on a computer and where the computer program may be embodied on a computer readable medium. Examples of tangible (or non-transitory) storage media include disks, thumb drives, solid-state memory, memory cards etc. and do not include propagated signals. The software can be suitable for execution on a parallel processor or a serial processor such that the method steps may be carried out in any suitable order, or simultaneously.

This application acknowledges that firmware and software can be valuable, separately tradable commodities. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

The preferred features may be combined as appropriate, as would be apparent to a skilled person, and may be combined with any of the aspects of the invention.

### BRIEF DESCRIPTION OF THE DRAWINGS

Embodiments of the invention will be described, by way of example, with reference to the following drawings, in which:

FIG. 1 is a schematic diagram of a filling station where an embodiment of the invention may be used;

FIG. 2 is a schematic diagram of a system for fuel storage tank inventory management at a filling station according to a first embodiment of the present invention;

FIG. 3 is a view of a screen presented by a graphical user interface of the system of FIG. 2;

FIG. 4 is a view of a further screen presented by the graphical user interface of the system of FIG. 2;

FIG. 5 is a view of a yet further screen presented by the graphical user interface of the system of FIG. 2

FIG. 6 is a flow diagram of a method for predicting fuel stocks carried out by the system of FIG. 1 according to the embodiment of the invention; and

FIG. 7 is a schematic diagram of a system for fuel storage tank inventory management at multiple filling stations according to a second embodiment of the present invention.

Common reference numerals are used throughout the figures to indicate similar features.

### DETAILED DESCRIPTION

An embodiment of the present invention is described below by way of example only. These examples represent the best ways of putting the invention into practice that are currently known to the Applicant although they are not the only ways in which this could be achieved. The description sets forth the functions of the example and the sequence of steps for constructing and operating the example. However, the same or equivalent functions and sequences may be accomplished by different examples.

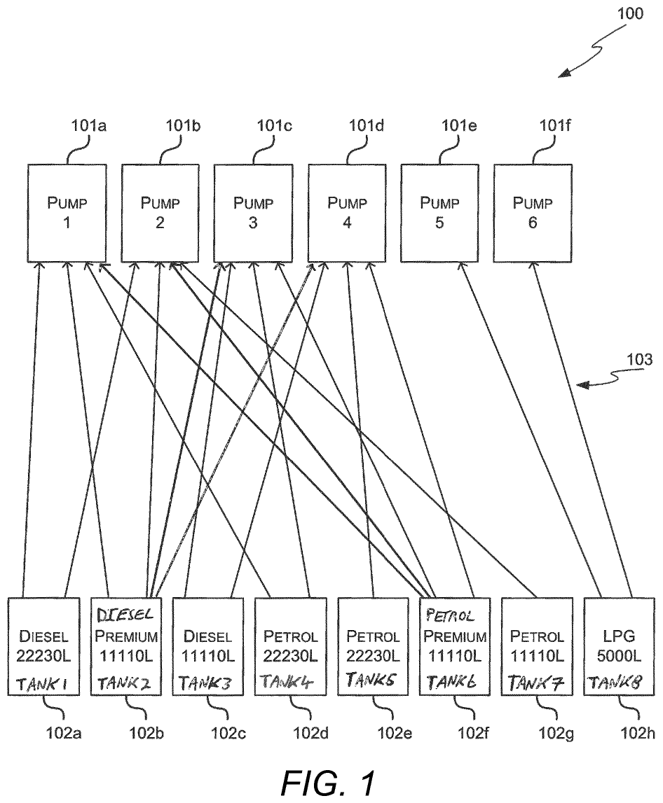

FIG. 1 illustrates an example of a filling station where a fuel storage tank inventory management system according to an embodiment of the present invention may be used. A filling station, also commonly known as a service station, petrol filling station, forecourt, garage or gas station, is a fuel supply site selling fuel for road vehicles to customers. The customers may include retail customers, and may typically also include other types of customer, for example customers provided with fuel under a contract, or customers using fuel cards.

A filling station may sell one or more different fuel types and grades, and each fuel type and grade may be stored in one or more different storage tanks. For clarity and brevity, in the present application each unique combination of a type and a grade of fuel will be referred to as a fuel. Accordingly, different grades of the same type of fuel will be referred to as different fuels herein.

FIG. 1 illustrates by way of example a filling station 100. In general, a filling station 100 will have one or more pumps 101, each for the supply of fuel to customers. In the illustrated example, the filling station 100 has six pumps 101a to 101f, which may be identified as pumps 1 to 6 respectively. The filling station 100 sells petrol (that is, standard grade petrol), premium grade petrol, diesel (that is standard grade diesel), premium grade diesel, and liquid petroleum gas (LPG), that is, three fuel types, with two of the fuel types each being sold in two different grades, for a total of five unique fuel/grade combinations. As explained above, each of these unique fuel/grade combinations will be referred to as a fuel herein, so that the filling station can be regarded as selling five different fuels. The six pumps 101a to 101f are arranged so that each of the pumps 101a to 101d can supply each of standard grade petrol, premium grade petrol, standard grade diesel and premium grade diesel to customers, while the pumps 101e and 101f can only supply LPG to customers.

In general, a filling station 100 will have one or more fuel storage tanks 102. In the illustrated example, the filling station 100 has eight underground fuel storage tanks 102a to 102h, which may be identified as tanks 1 to 8 respectively. Tank 102a contains diesel and has a maximum capacity of 22,230 liters. Tank 102b contains premium diesel and has a maximum capacity of 11,110 liters. Tank 102c contains diesel and has a maximum capacity of 11,110 liters. Tank 102d contains petrol and has a maximum capacity of 22,230 liters. Tank 102e contains petrol and has a maximum capacity of 22,230 liters. Tank 102f contains premium petrol and has a maximum capacity of 11,110 liters. Tank 102g contains petrol and has a maximum capacity of 11,110 liters. Tank 102h contains LPG and has a maximum capacity of 5,000 liters.

In order to allow the pumps 101a to 101f to provide the desired fuels the pipework 103 at the filling station connects pump 101a to tanks 102a, 102b, 102d and 102f, connects pump 101b to tanks 102a, 102b, 102f, and 102g, connects pump 101c to tanks 102b, 102c, 102d, and 102f, connects pump 101d to tanks 10cb, 102c, 102e, and 102f, connects pump 101e to tank 102h, and connects pump 101f to tank 102h.

Thus, tank 1 102a supplies diesel fuel to two pumps 101a and 101b and has a maximum capacity of 22,230 liters, while tank 3 102c also supplies diesel fuel to two pumps 101c and 101d, but only has a capacity of 11,100 liters. Tank 2 102b supplies premium diesel fuel to four pumps 101a to 101d and has a maximum capacity of 11,110 liters. Tank 6 102f supplies premium petrol fuel to four pumps 101a to 101d and also has a maximum capacity of 11,110 liters. Tank 4 102d supplies petrol fuel to two pumps 101a and 101c and has a maximum capacity of 22,230 liters, while tank 5 102e supplies petrol fuel to only one pump 101d and also has a maximum capacity of 22,230 liters, and tank 7 102g supplies petrol fuel to only one pump 101b and has a maximum capacity of 11,110 liters. Finally, tank 8 102h supplies LPG fuel to two pumps 101e and 101f and has a maximum capacity of 5,000 liters.

It will be understood that because the storage of some of the different fuels (that is, different fuel and grade combinations) on sale is split between multiple separate storage tanks, which may contain different amounts of fuel and supply different numbers of pumps, the task of fuel storage tank inventory management for all of the different fuel storage tanks 102 at the filling station 100 may be complex to carry out efficiently. This is particularly the case because it is usually not possible, for safety reasons, logistics reasons, and to prevent fuel contamination, to transfer fuel between different storage tanks in a filling station, even when the storage tanks contain the same fuel, that is, the same fuel type and grade combination.

The task of fuel storage tank inventory management may be further complicated by limitations in the amounts of liquid fuels which can be physically delivered by road tanker vehicles. Typically a road tanker vehicle will have a tank broken up into a number of fixed size tank cells, for example a road tanker vehicle with a fuel capacity of 36,000 liters may have a tank comprising six cells each having a capacity of 6,000 liters. Each cell may hold a different fuel, such as various grades of petrol and diesel fuel, but each cell can hold only a single fuel. It is common for fuel suppliers to only accept fuel orders for a full road tanker vehicle load of fuel, in order to avoid the risk and environmental and financial cost of the additional road tanker vehicle journeys which would be made necessary by making deliveries with road tanker vehicles which are only partly full. As a result, it will commonly only be possible for a user to order fuel in amounts corresponding to the sizes of the cells of the different road tanker vehicles used by their fuel supplier.

It might be expected that a simpler arrangement may be preferred in a new build filling station, for example, it may be preferred for each fuel to be stored in a single dedicated storage tank. However, such a simple arrangement could be difficult to adapt if the number of fuels to be sold changes over time, so a more complex arrangement with more storage tanks may be preferred to provide increased long term flexibility. Further, many existing filing stations have relatively complex arrangements of fuel storage tanks for legacy reasons, because it is generally more physically and economically practical to increase storage capacity at a filling station by adding new storage tanks than by enlarging existing storage tanks or replacing existing storage tanks with larger storage tanks.

The example of FIG. 1 is provided only as an explanatory example to illustrate that a filling station 100 may have more than one tank 102 storing the same fuel, and may have different pumps 101 selling the same fuel but drawing that fuel from different tanks 102. The number of pumps 101, the number, types and grades of fuel sold, the number of storage tanks 102, and the interconnections between the pumps 101 and tanks 102 may all be varied in specific implementations of the invention.

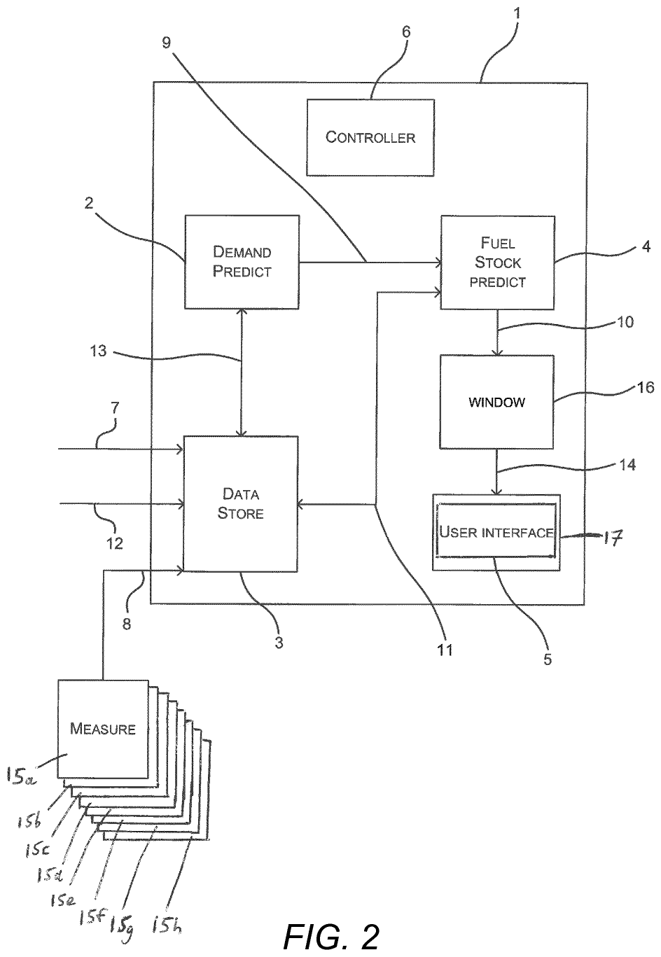

FIG. 2 illustrates a system for carrying out fuel storage tank inventory management at a specific filling station by predicting future demand for the different fuels, that is different types and/or grades of fuel, available at that specific filling station, determining how this predicted level of demand will affect the fuel stock levels of the different fuels, and determining windows for replenishment of the fuel stocks of the different fuels in the different storage tanks 102.

In the present application the amount of a specific fuel (that is, a specific type and grade of fuel) sold to customers, and so removed from storage at the filing station and taken away by the customers, is regarded as the amount of demand for that fuel, so that a predicted level of demand for a fuel is a prediction of the amount of that fuel which will be sold.

As is explained above, filling stations commonly stock a plurality of fuels (that is, a plurality of different fuel types and/or grades), which are each stored separately, in separate fuel storage tanks.

In FIG. 2, according to a first embodiment of the invention a fuel storage tank inventory management system 1 at a filling station comprises a fuel demand prediction engine 2, a data store 3, a fuel stock predictor 4, a user interface 5, and a system controller 6.

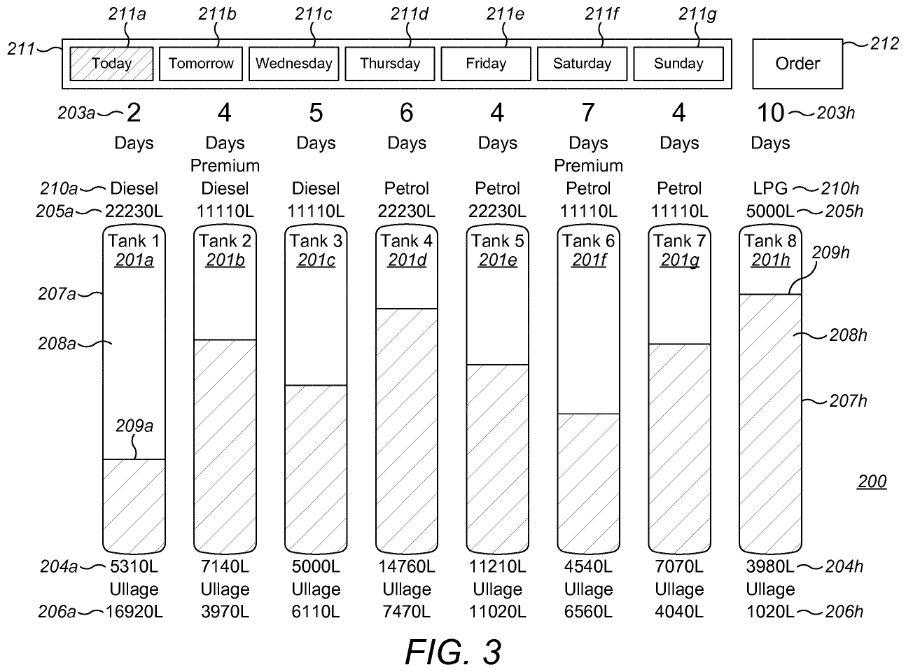

FIG. 3 illustrates a user interface 5 of the fuel tank inventory management system 1 according to the first embodiment of the invention.

In the illustrated example of FIGS. 2 and 3 the fuel tank inventory management system 1 is operating at the exemplary filling station 100 illustrated in FIG. 1. As is discussed above, the exemplary filling station 100 comprises eight separate fuel storage tanks 102 in which five different fuels (that is, five different fuel type and/or grade combinations) are stored.

An overview of the operation of the fuel storage tank inventory management system 1 is that the fuel storage tank inventory management system 1 is provided with a number of information inputs 7 regarding current and anticipated future factors which may influence current and future fuel demand for the different fuels stored in each of the storage tanks 102 of the filling station 100, stored fuel information 8 regarding the current amount of each fuel stored in each of the storage tanks 102 of the filling station 100, and site specific characteristics information 12, and these are stored in the data store 3 under the control of the system controller 6. The site specific characteristics information 12 includes information identifying which fuel (that is, which type and grade of fuel) is stored in each of the fuel storage tanks 102 of the filling station 100.

The prediction engine 2 operates on stored data 13 selected from the stored information inputs 7 and site specific characteristics information 12 using predictive tools taken from the data store 3 to generate predicted values of future fuel demand 9 for the fuel stored in each of the fuel storage tanks 102. The predicted values of future fuel demand 9 and the stored fuel information 8 are then provided to the fuel stock predictor 4. The fuel stock predictor 4 uses the predicted values of future fuel demand 9 and stored fuel information 8 to determine predicted amounts 10 of stored fuel in each of the fuel storage tanks 102 of the filling station 100 at different times in the future. The predicted amounts 10 of stored fuel in each of the fuel storage tanks 102 of the filling station 100 at different times in the future are then provided to a window determining unit 11, and may also be stored in the data store 3. The window determining unit 11 determines a safe window 14 for a fuel supply delivery to be made for each of the fuel storage tanks 102 of the filling station 100. In this context a “safe” window means a time window or window of which avoids the corresponding one of the storage tanks 102 inadvertently running dry. Use of the safe windows 14 to schedule fuel deliveries may avoid replenishing the fuel storage tanks 102 at an unnecessarily early time. The safe windows 14 are then provided to the user interface 5 for display to a user or operator of the system 1 for information and action. In some examples the operator of the system 1 may be a member of staff, such as a manager, at the filling station 100. In other examples the system 1 may be remotely operated by a remote operator, such as a head office of a chain of filling stations including the filling station 100.

The prediction engine 2 may be an expert system in which the different values of the different parameters which can affect fuel demand at the service station 100 are processed using predictive tools stored in the data store 3, and the cumulative effects of all of the different parameters are combined to provide an expected fuel demand value for the fuel in each of the tanks 102 for a future time period.

In the illustrated example the stored fuel information 8 is obtained from a plurality of measuring means 15, which each measure the amount of fuel in a respective one of the storage tanks 102 at the filling station and provide this to the fuel tank inventory management system 1. In the illustrated example there are eight measuring means 15a to 15h, which each measure the amount of fuel in a respective one of the storage tanks 102a to 102h at the filling station. In other examples the stored fuel information 8 may alternatively, or additionally as a cross-check, be obtained from other parts of the filling station equipment, for example from the filling station site controller or a filling station point of sale system. In some examples the stored fuel information 8 may be provided by one or more measuring means which measure the amount of fuel in each storage tank 102 at the filling station 100 and provide these amounts to the filling station point of sale system, or the filling station site controller, which in turn provide them to the fuel tank inventory management system 1.

The fuel storage tank inventory management system 1 is shown schematically in FIG. 2. It will be understood that the fuel storage tank inventory management system 1 may in practice comprise a number of other components, but these are not described or shown to improve clarity and to avoid obscuring the scope of the present invention.

In the illustrated example of FIG. 2 the fuel storage tank inventory management system 1 is provided by a suitable general purpose computer at the filling station 100 running fuel stock prediction software. The different functional parts of the fuel storage tank inventory management system 1 may be provided by software modules operating on the general purpose computer. This general purpose computer may, for example, be a desktop computer, a laptop computer, a tablet, or a smartphone.

The user interface 5 is a graphical user interface (GUI) 5 which is rendered and presented to an operator on a visual display 17 of the fuel storage tank inventory management system 1. In examples where the fuel storage tank inventory management system 1 is be provided by software modules operating on a general purpose computer the visual display 17 may be a visual display of the general purpose computer, or a visual display connected to the general purpose computer.

The GUI 5 comprises a number of different screens which may be selectively rendered on the display 17 in response to operator instructions. In the illustrated embodiment the different screens which can be rendered by the GUI 5 comprise screens indicating the current status of the stocks of fuel in the different storage tanks 102 at the filling station 100 and the predicted status of the stocks of fuel in the different storage tanks 102 at the filling station 100 at different times in the future, including the safe windows for the different storage tanks 102. The information displayed on these screens may assist an operator in scheduling fuel deliveries to the filling station 100.

FIG. 3 illustrates a current status screen 200 displaying current information regarding the status of the stocks of fuel stored in the storage tanks 102 at the filling station 100 according to an embodiment.

The current status screen 200 comprises a plurality of tank display areas 201, each of the tank display areas 201 displaying information regarding the current status of a different specific one of the fuel storage tanks 102 at the filling station 100. In the illustrated example there are eight fuel storage tanks 102a to 102h at the exemplary filling station 100, and there are a corresponding eight tank display areas 201a to 201h in the current status screen 200.

In the current status screen 200 each tank display area 201 displays information regarding the current status of one of the fuel storage tanks 102. For example, the tank display area 201a displays information regarding the current status of the fuel storage tank 102a.

Each tank display area 201 comprises a tank identifier 202 identifying which of the fuel storage tanks 102 the information in the tank display area 201 corresponds to. For example, the tank display area 201a comprises a tank identifier 202a which identifies the information in the tank display area 201a as corresponding to fuel storage tank 102a, identified as “Tank 1”

Each tank display area 201 also comprises a safe window length value 203 indicating the remaining length of the safe window for refilling the corresponding fuel storage tank 102. For example, the tank display area 201a indicates a safe window length value 203a of 2 days for the fuel storage tank 102a. The indicated safe window length value 203 is the safe window 14 determined by the window determining unit 11.

The indicated safe window length value 203 is the number of future days of predicted fuel demand which will remain in the corresponding fuel storage tank 102 at the end of the current day. Thus, the corresponding fuel storage tank 102 will not be emptied and run out of stored fuel on the day when the indicated safe window length value 203 is zero, but on the following day.

Each tank display area 201 also comprises a fuel amount value 204 indicating the current amount of fuel stored in the corresponding fuel storage tank 102. For example, the fuel amount value 204a indicates that the fuel storage tank 102a contains 5310 liters of fuel. The indicated fuel amount value 204 is obtained from the stored fuel information 8 stored in the data store 3.

Generally, impurities, such as dirt, tend to accumulate in the bottoms of fuel storage tanks over time so that it is generally preferred not to deplete the amount of fuel in the tank below a predetermined minimum amount or level in order to avoid providing contaminated or dirty fuel to customers. In the illustrated example the fuel amount value 204 is the current amount of fuel stored in the corresponding fuel storage tank 102 above this predetermined minimum amount, so that the fuel amount value 204 corresponds to the amount of fuel in the storage tank 102 which is safely available for removal and sale to customers. An indication of the value of this available amount of fuel will generally be more useful to an operator of the system than the value of the absolute amount of fuel in the storage tank, which will include fuel which cannot be safely removed and sold. In alternative examples the indicated fuel amount value 204 may be the current absolute amount of fuel stored in the corresponding fuel storage tank 102.

In some examples each fuel storage tank 102 may have a low fuel level sensor and alarm in order to provide a warning that the amount of stored fuel has reached, or dropped below, a predetermined minimum value so that the supply of fuel from the tank can be stopped to avoid providing contaminated or dirty fuel to customers. In such examples the predetermined minimum amount may conveniently be set to be the same as, or slightly above, this minimum value.

Each tank display area 201 also comprises a tank capacity value 205 indicating the maximum amount of fuel which can be stored in the corresponding fuel storage tank 102. For example, the tank capacity value 205a indicates that the maximum amount of fuel which can be stored in the fuel storage tank 102a is 22230 liters of fuel. The indicated tank capacity value 205 is obtained from the site specific characteristics information 12 stored in the data store 3.

In the illustrated example the tank capacity value 205 is the difference between the maximum amount of fuel which can be stored in the tank and the predetermined minimum amount discussed above, so that the tank capacity value 205 is an effective tank capacity value 205 which corresponds to the maximum amount of fuel in the storage tank 102 which could be available for removal and sale. This maximum available amount of fuel will generally be more useful to an operator of the system than the absolute maximum amount of fuel which could be stored in the storage tank 102 including fuel which cannot be safely removed and sold. In alternative examples the tank capacity value 205 may be the absolute maximum amount of fuel which could be stored in the corresponding fuel storage tank 102.

Each tank display area 201 also comprises a tank ullage value 206 indicating the maximum amount of fuel which can be added to the corresponding fuel storage tank 102. For example, the tank ullage value 206a indicates that the maximum amount of fuel which can be added to the fuel storage tank 102a is 17920 liters of fuel. In the illustrated example the indicated tank ullage value 206 is calculated as the difference between the effective tank capacity value 205 and the fuel amount value 204. In alternative examples the indicated tank ullage value 206 may be calculated as the difference between the absolute tank capacity value 205 and the current absolute amount of fuel stored in the corresponding fuel storage tank 102.

In examples where only one of the tank capacity value 205 and the fuel amount value 204 is calculated based on the available amounts of fuel it will be necessary to take the predetermined minimum amount into account when calculating the tank ullage value 206.

Each tank display area 201 also comprises a fill level bar 207 graphically representing the current amount of fuel stored in the corresponding fuel storage tank 102 relative to capacity of the fuel storage tank 102. The fill level bar 207 comprises a vertically oriented elongate bar 208 containing a horizontal divider 209 located at a position along the length of the elongate bar 208. The position of the horizontal divider 209 at a height above the bottom of the elongate bar 208 comprising the same proportion of the total length of the elongate bar as the proportion of the tank capacity value 205 which is comprised by the fuel amount value 204, which may be regarded as the proportional “fullness” of the corresponding fuel storage tank 102. The elongate bar 208 is filled in using contrasting colors above and below the horizontal divider 209 to provide a clear indication of the fill level of the corresponding fuel storage tank 102. The displayed position of the horizontal divider 209 may be based on the proportional sizes of the tank capacity value 205 and the fuel amount value 204.

Each tank display area 201 also comprises a fuel identifier 210 indicating what fuel, that is, what fuel type, and where appropriate fuel grade, is stored in the corresponding fuel storage tank 102. For example, the fuel identifier 210a indicates that the fuel storage tank 102a contains the fuel type and grade “diesel”, that is, standard grade diesel fuel. The indicated fuel identifier 210 is obtained from the site specific characteristics information 12 stored in the data store 3.

The tank display area 201a is discussed in detail above by way of example. As is shown in FIG. 3, corresponding values and graphical indications regarding the other fuel storage tanks 102b to 102h at the filling station 100 are respectively shown in the other tank display areas 201b to 201h.

The current status screen 200 of the GUI 5 as shown in FIG. 3 displays information regarding the current status of the stocks of fuel in the different storage tanks 102 at the filling station 100. As is explained above, the GUI 5 can also display status screens showing the predicted status of the stocks of fuel in the different storage tanks 102 at the filling station 100 at different times in the future.

Each status screen of the GUI 5 comprises a button bar 211 comprising a plurality of buttons 211a to 211g which each correspond to a different screen. The button bar 211 allows the selection of different screens for display, and indicates which screen is currently being displayed.

In the illustrated embodiment, as shown for example in FIG. 3, the button bar 211 comprises seven buttons 211a to 211g respectively corresponding to the status of the stocks of fuel in the storage tanks 102 of the filling station 100 currently, and on the next six consecutive future days.

As is explained above, the illustrated embodiment of FIG. 3 shows the current status screen 200 of the GUI 5, which displays information regarding the current status of the stocks of fuel in the different storage tanks 102 at the filling station 100. As is shown in FIG. 3, in the current status screen 200 the button 211a of the button bar 211, labelled “Today” is highlighted to indicate to the operator that the current status is being displayed. In order to select a different screen for display the operator may select one of the other buttons 211 b to 211g of the button bar 211. When another screen is being rendered the rendering of the current status screen 200 by the GUI 5 may be selected by selecting the button 211a of the button bar

In the illustrated embodiment of FIG. 3 the current status screen 200 is being displayed on a Monday. Accordingly in addition to the button 211a corresponding to the current status being labeled “Today”, the button 211b corresponding to the status on the immediately following day is labelled “Tomorrow”, the button 211c corresponding to the status on the next following day is labelled “Wednesday”, the button 211d corresponding to the status on the next following day is labelled “Thursday”, the button 211e corresponding to the status on the next following day is labelled “Friday”, the button 211f corresponding to the status on the next following day is labelled “Saturday”, and the button 211g corresponding to the status on the next following day is labelled “Sunday”. In other examples different labels may be used for the buttons 211a to 211g, provided that the labels indicate to a user which times the corresponding screens relate to. In some examples the labels may be dates. In some examples the labels may be both days and dates.

The days of the week and/or dates indicated by the labels on the buttons 211c to 211g are automatically updated based on the current day of the week and date. The necessary techniques to do this are well known to the skilled person in the technical field of the present disclosure, and do not need to be described in detail herein.

Selection of a button 211a to 211g in the button bar 211 may be carried out in any convenient manner, for example by moving a cursor onto a button of interest and activating an operator input means. Conveniently, in examples where the visual display 17 is a touchscreen a button of interest may be selected by pressing on the visual display at the position of that button. The GUI 5 detects the selection of a button 211 a to 211g as a selection input by the user.

In addition to the tank display areas 201 and the button bar 211, each status screen of the GUI 5 further comprises an order button 212. The order button 212 can be selected by the user to instruct the fuel storage tank inventory management system 1 to generate an order for a fuel delivery, as will be discussed in more detail below.

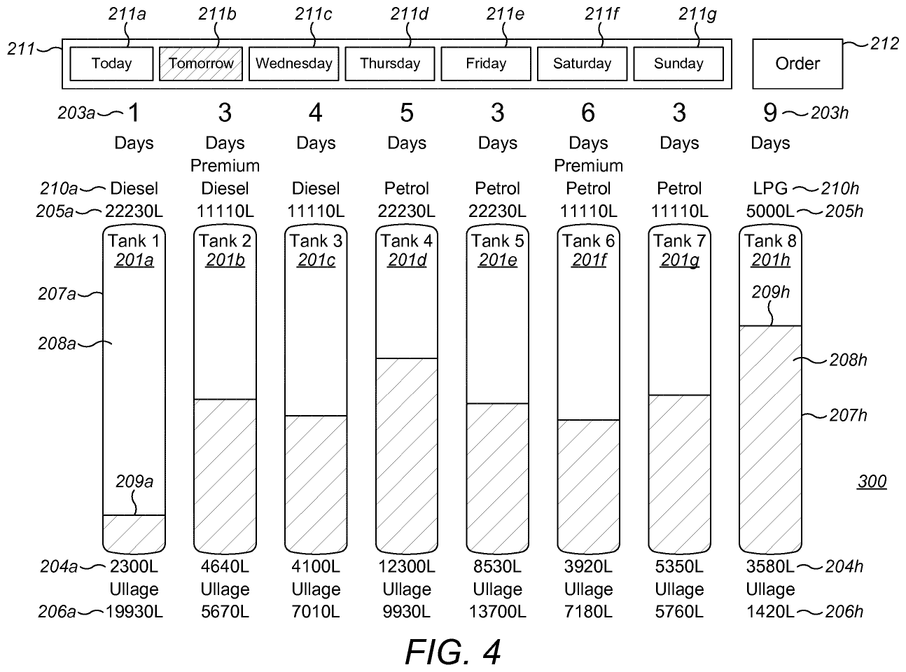

FIG. 4 illustrates a next day status screen 300 displaying predicted information regarding the status of the stocks of fuel stored in the storage tanks 102 at the filling station 100 on the next day, that is, the day following the current day, according to an embodiment. The rendering of the next day status screen 300 by the GUI 5 may be selected by selecting the button 211b of the button bar 211.

As is shown in FIG. 4, in the next day status screen 300 the button 211b of the button bar 211 labelled “Tomorrow” is highlighted to indicate to the operator that the predicted status for the next day after the current day is being displayed.

The next day status screen 300 comprises the same plurality of tank display areas 201 as the current status screen 200. Accordingly, in the illustrated example there are eight tank display areas 201a to 201 h in the next day status screen 300.

On the next day status screen 300 each tank display area 201 displays information regarding the predicted status of one of the fuel storage tanks 102 at the end of the following day, that is, the end of the next day following the current day. For example, the tank display area 201a displays information regarding the predicted status of the fuel storage tank 102a at the end of the day following the current day.

In general, the identifier associated with each fuel storage tank 102, the maximum amount of fuel which can be stored in each fuel storage tank 102, and the fuel stored in each fuel storage tank 102 will not be expected to change from day to day, and changes to this information will not be predicted by the fuel storage tank inventory management system 1, and in particular will not be predicted by the prediction engine 2 or the fuel stock predictor 4. This information would be expected to change only if major changes are made to the infrastructure or operation of the filling station. In the event that this information does change it will be necessary to update the site specific characteristics information 12 stored in the data store 3.

Accordingly, in the next day status screen 300 the displayed tank identifier 203, effective tank capacity value 205 and fuel identifier 210 will be the same as in the current status screen 200.

In the next day status screen 300 the indicated safe window length value 202 of each tank display area 201 will be the length of the predicted safe window for refilling the corresponding fuel storage tank 102 which will remain at the end of the day that the next day status screen 300 relates to, that is, the day following the current day. For example, in the next day status screen 300 the tank display area 201 a indicates a remaining safe window length value 202a of 1 day for the fuel storage tank 102a. The indicated safe window length value 202 is the length of the safe window 14 determined by the window determining unit 11 which will remain at the end of the day that the next day status screen 300 relates to, that is, the day following the current day.

In the next day status screen 300 the indicated fuel amount value 204 of each tank display area 201 indicates a predicted fuel amount value. This predicted fuel amount value is the amount of fuel predicted to be stored in the corresponding fuel storage tank 102 at the end of the day that the next day status screen 300 relates to, that is, the day following the current day. For example, the fuel amount value 204a indicates that the fuel storage tank 102a is predicted to contain 2300 liters of fuel at the end of the day following the current day. The indicated fuel amount value 204 is obtained from the predicted amounts 10 of stored fuel determined by the fuel stock predictor 4 and stored in the data store 3.

In the next day status screen 300 the indicated tank ullage value 206 of each tank display area 201 indicates the maximum amount of fuel which it is predicted it will be possible to add to the corresponding fuel storage tank 102 at the end of the day that the next day status screen 300 relates to, that is, the day following the current day. For example, the tank ullage value 206a indicates that the maximum amount of fuel which it is predicted it will be possible to add to the fuel storage tank 102a at the end of the day following the current day is 19930 liters of fuel. In the illustrated example the indicated tank ullage value 206 is calculated as the difference between the effective tank capacity value 205, after taking into account any unusable volume in the tank due to dirt or sediment in the bottom of the tank and the predicted indicated fuel amount value 204.

In the next day status screen 300 the horizontal divider 209 of the fill level bar 207 is located at a position at a height above the bottom of the elongate bar 208 comprising the same proportion of the total length of the elongate bar as the proportion of the effective tank capacity value 205 which is comprised by the predicted indicated fuel amount value 204, which may be regarded as the predicted proportional “fullness” of the corresponding fuel storage tank 102.

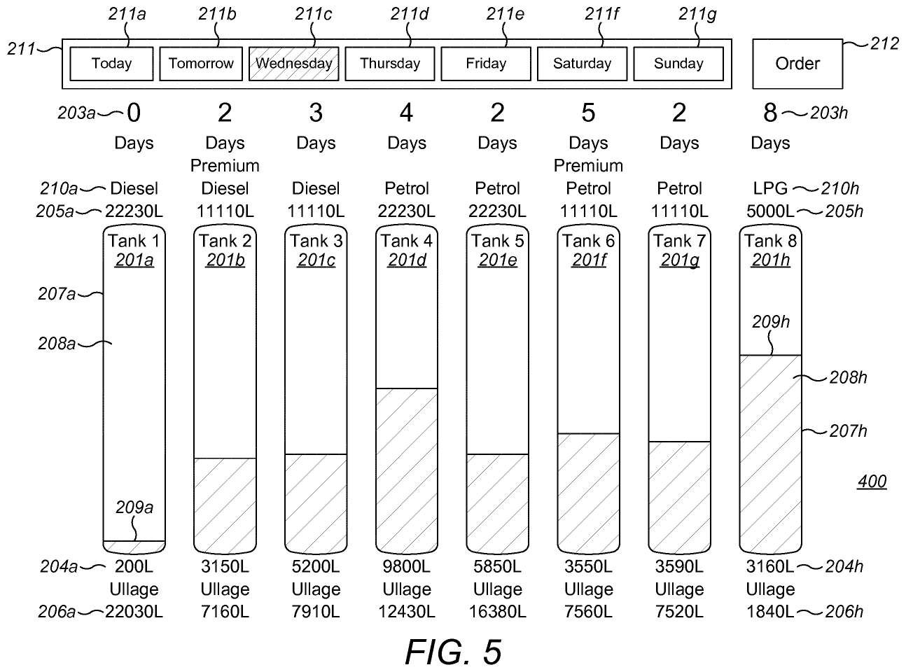

FIG. 5 illustrates a further future day status screen 400 displaying predicted information regarding the status of the stocks of fuel stored in the storage tanks 102 at the filling station 100 on the day two days after the current day, according to an embodiment. The rendering of the further future day status screen 400 by the GUI 5 may be selected by selecting the button 211c of the button bar 211.

As is shown in FIG. 5, in the next further future day status screen 400 the button 211c of the button bar 211, labelled “Wednesday” is highlighted to indicate to the operator that the predicted status for the day two days after the current day (Monday in the illustrated examples) is being displayed.

The further future day status screen 400 comprises the same plurality of tank display areas 201 as the current status screen 200 and the next day status screen 300. Accordingly, in the illustrated example there are eight tank display areas 201a to 201h in the further future day status screen 400.

For the same reasons as are explained above regarding the next day status screen 300, the tank identifier 203, effective tank capacity value 205 and fuel identifier 210 displayed in the further future day status screen 400 will be the same as in the current status screen 200 and the next day status screen 300.

In the further future day status screen 400 the indicated safe window length value 202 of each tank display area 201 will be the length of the predicted safe window for refilling the corresponding fuel storage tank 102 which will remain at the end of the day that the future day status screen 400 relates to, that is, the day two days after the current day. For example, in the further future day status screen 400 the tank display area 201a indicates a remaining safe window length value 202a of 0 day for the fuel storage tank 102a. The indicated safe window length value 202 is the length of the safe window 14 determined by the window determining unit 11 which will remain at the end of the day that the further future day status screen 400 relates to, that is, day two days after the current day.

In the further future day status screen 400 the indicated fuel amount value 204 of each tank display area 201 indicates a predicted fuel amount value. This predicted fuel amount value is the amount of fuel predicted to be stored in the corresponding fuel storage tank 102 at the end of the day that the further future day status screen 400 relates to, that is, the day two days after the current day. For example, the fuel amount value 204a indicates that the fuel storage tank 102a is predicted to contain 200 liters of fuel at the end of the day two days after the current day. The indicated fuel amount value 204 is obtained from the predicted amounts 10 of stored fuel determined by the fuel stock predictor 4 and stored in the data store 3.

In the further future day status screen 400 the indicated tank ullage value 206 of each tank display area 201 indicates the maximum amount of fuel which it is predicted it will be possible to add to the corresponding fuel storage tank 102 at the end of the day that the further future day status screen 400 relates to, that is, the day two days after the current day. For example, the tank ullage value 206a indicates that the maximum amount of fuel which it is predicted it will be possible to add to the fuel storage tank 102a at the end of the day two days after the current day is 22030 liters of fuel. The indicated tank ullage value 206 is calculated as the difference between the effective tank capacity value 205, after taking into account any unusable volume in the tank due to dirt or sediment in the bottom of the tank and the predicted indicated fuel amount value 204.

In the further future day status screen 400 the horizontal divider 209 of the fill level bar 207 is located at a position at a height above the bottom of the elongate bar 208 comprising the same proportion of the total length of the elongate bar as the proportion of the effective tank capacity value 205 which is comprised by the predicted indicated fuel amount value 204, which may be regarded as the predicted proportional “fullness” of the corresponding fuel storage tank 102.

The GUI 5 can display further day status screens in response to selection of each of the buttons 211d to 211g of the button bar 211. Each of these further day status screens will operate similarly to the further future day status screen 400 to display safe window length values 202, indicated fuel amount values 204, indicated tank ullage values 206, and horizontal dividers 209 of the fill level bars 207 according to the predicted values of these variables at the end of the respective day that each screen relates to. Accordingly, the different screens can display the status of the fuel stored in the different fuel storage tanks 102 at different times. In the illustrated embodiment the different screens can display the current status and the predicted status at the end of each of the six consecutive following days. The different status screens are displayed in response to selection of different respective ones of the buttons 211a to 211g in the button bar 211, and the respective button bar is highlighted in each status screen to indicate to the operator which day the information in the status screen relates to. As discussed above regarding the next day status screen 300, the tank identifier 203, tank capacity value 205 and fuel identifier 210 displayed in the all of the different status screens will be the same.

Thus, the GUI 5 of the fuel tank inventory management system 1 provides the final day of the safe delivery window and the current amount of stored fuel, and the predicted amount of fuel stored at the end of each day within the safe delivery window for each fuel storage tank 102 at the filling station 100 to the operator through the status screens displayable in the GUI 5. Each of the status screens, such as the status screens 200, 300 and 400, presentable by the GUI 5 provides information regarding the status of fuel levels in the different fuel storage tanks 102 of the filling station 100 at the current time, or as predicted at specific future times. By selecting different ones of the status screens, such as the status screens 200, 300 and 400, for display, the operator can scroll forward and back through time and easily understand how the amounts of the fuels stored in the different storage tanks 102 at the filling station 100 will change, in addition to their respective safe delivery windows, so enabling the operator to request and schedule fuel deliveries of the desired fuels and amounts at appropriate times, and preferably within the safe delivery windows of the fuels in the respective storage tanks 102.

The operator can then use the GUI 5 to request and schedule one or more fuel deliveries of desired amounts of different fuels within the respective safe delivery windows by selecting the order button 212.

An example of use of the GUI 5 of the fuel tank inventory management system 1 will now be described with reference to FIGS. 3 to 5.

In the illustrated example the filling station 100 has a fuel supply contract with a fuel supplier requiring a full days notice for fuel deliveries, and allowing only the day of delivery to be selected, not the time. As a result, in the illustrated example, if an order for fuel is made on a particular day the earliest day for which the delivery of fuel can be requested and carried out will be two days later, that is, the day after the day after the day on which the order is made, and the order may be delivered at any time on the requested delivery day. As a result, in order to avoid the risk of a fuel storage tank 102 being depleted to a level below the predetermined minimum value it will be necessary to place an order two days before the end of the safe delivery window to ensure that the delivery is made before the end of the safe delivery window. The length of the delay between the submission of an order for fuel delivery and the ordered fuel being delivered will generally be determined by the delivery terms of the fuel supplier, and possibly by practical considerations related to the location of the filling station 100. The length of the delay will be known for any specific filling station 100, and is recorded in the site specific characteristics information 12 stored in the data store 3.

The fuel storage tank inventory management system 1 is arranged to alert a user when any of the fuel storage tanks 102 approach the end of their respective safe delivery window and there is an urgent need to order fuel to refill that tank in order to avoid the fuel storage tank 102 becoming empty and no longer able to supply fuel. In order to do this, the system 1 compares the length of the calculated safe delivery window for each of the fuel storage tanks 102 to the predetermined threshold of the known length of delay for fuel deliveries recorded in the site specific characteristics information 12 stored in the data store 3. If any of the fuel storage tanks 102 are determined to have a safe delivery window which is equal to or shorter than the stored length of delay for fuel deliveries the indicated safe delivery window value 203 for that fuel storage tank 102 is highlighted in the status screens 200, 300, 400 displayed on the GUI 5 to draw a users attention to them.

Conveniently, the indicated safe delivery window value 203 for a fuel storage tank 102 having an indicated safe delivery window 203 which is equal to or shorter than the stored length of delay for fuel deliveries may be highlighted by being displayed in a contrasting color to the indicated safe delivery window values 203 for other fuel storage tanks 102. In the illustrated example, the indicated safe delivery window value 203 for a fuel storage tank 102 having a safe delivery window which is equal to or shorter than the stored length of delay for fuel deliveries is displayed in red, while the safe delivery window values 203 for other fuel storage tanks 102 are displayed in green or blue.

In some examples one or more notifications that fuel should be ordered to refill the identified fuel storage tank 102 may be displayed by the fuel storage tank inventory management system 1. Such notification(s) may be made on the GUI 5, or on other parts of the system 1. In some examples a message notifying that fuel should be ordered to refill the identified fuel storage tank 102 may be sent to a user communications device separate from the fuel storage tank inventory management system 1, for example by a text message.

Further, when status screens for future days, such as the next day status screen 300 and the further future day status screen 400, are to be displayed on the GUI 5, the indicated safe window length values 203, which are the lengths of the predicted safe windows for refilling corresponding fuel storage tanks 102 which will remain at the end of the day that the future day status screen relates to, are also compared to the stored length of delay for fuel deliveries. Any indicated safe window length value 203 which is equal to or shorter than the stored length of delay for fuel deliveries may be highlighted by being displayed in a contrasting color to the indicated safe delivery window values 203 for other fuel storage tanks 102, to indicate to a user that there will be an urgent need to order fuel to refill the corresponding fuel storage tank 102 on the day which the displayed status screen for a future day relates to.

In the illustrated example, on the day when the current status screen 200 of FIG. 3 is displayed the safe window 14 determined by the window determining unit 11 for “Tank 1”, the fuel storage tank 102a, is 2 days, which is equal to the length of delay for fuel deliveries to the filling station 100, and the safe windows 14 determined by the window determining unit 11 for the other fuel storage tanks 102b to 102h are all greater than 2 days, and so greater than the length of delay for fuel deliveries to the filling station 100.

Accordingly, when the user selects the current status screen 200 for display on the GUI 5, the safe window length value 203a of 2 days for the fuel storage tank 102a displayed in the tank display area 201a of the current status screen 200 is displayed in a red color, to highlight it so that it stands out in contrast to the safe window length values 203b to 203h for the remaining fuel storage tanks 102b to 102h, which are displayed in green and blue.

The display of the current status screen 200 on the GUI 5 may be selected by the user selecting the button 211a. Conveniently, the current status screen 200 may be the default status screen displayed when no selection of a specific status screen is carried out by the user. This may assist in avoiding confusion by the user as to which day the information on the currently displayed status screen relates to.

The user can select the display of the next day status screen 300 by selecting the button 211b on the button bar 211. When the next day status screen 300 is displayed, the safe window length value 203a of 1 day for the fuel storage tank 102a displayed in the tank display area 201a of the current status screen 200 is displayed in a red color. As discussed above, this is because the safe window 14 determined by the window determining unit 11 for “Tank 1”, the fuel storage tank 102a, is 2 days, which is equal to the length of delay for fuel deliveries to the filling station 100. The remaining fuel storage tanks 102b to 102h all have safe windows 14 and displayed safe window length values 203b to 203h greater than 2 days, and so greater than the length of delay for fuel deliveries to the filling station 100. Accordingly, the safe window length values 203b to 203h for the fuel storage tanks 102b to 102h are displayed in green and blue.

The user can select the display of the further future day status screen 400 by selecting the button 211c on the button bar 211. When the further future day status screen 400 is displayed, the safe window length value 203a of 0 days for the fuel storage tank 102a displayed in the tank display area 201a of the current status screen 200 is displayed in a red color. As discussed above, this is because the safe window 14 determined by the window determining unit 11 for “Tank 1”, the fuel storage tank 102a, is 2 days, which is equal to the length of delay for fuel deliveries to the filling station 100.

In the further future day status screen 400 the fuel storage tanks 102b, 102e and 102g all have displayed safe window length values 203b, 203e and 203e respectively of 2 days, equal to the length of delay for fuel deliveries to the filling station 100. Accordingly, the safe window length values 203b, 203e and 203g for these fuel storage tanks 102b, 102e and 102g are displayed in red, even though their determined safe windows 14 are greater than 2 days.

In the further future day status screen 400 the remaining fuel storage tanks 102c, 102d, 102f and 102h all have safe windows 14 and displayed safe window length values 203c, 203d, 203f and 203h greater than 2 days, and so greater than the length of delay for fuel deliveries to the filling station 100. Accordingly, the safe window length values 203c, 203d, 203f and 203h for these fuel storage tanks 102c, 102d, 102f and 102h are displayed in green and blue.

The other status screens display the safe window length values of the different fuel storage tanks 102 in a similar manner to that described above. The status screens display the safe window length values of fuel storage tanks 102 having a safe window 14 equal to, or less than the length of delay of fuel deliveries to the filling station 100, or a displayed safe window length value in the currently displayed status screen equal to, or less than the length of delay of fuel deliveries to the filling station 100 in a red color, to highlight them.

Accordingly, by moving between the status screens for the different days a user can readily and clearly identify when each of the fuel storage tanks 102 at the filling station 100 will be empty, and, more importantly, the latest time when a fuel delivery must be requested in order for the fuel delivery to be made received before the respective fuel storage tank 102 runs out of fuel for supply to customers.

When the user wishes to request a fuel delivery the user can select the order button 212. In response to user selection of the order button 212 the fuel storage tank inventory management system 1 generates a fuel order form and displays this to the user on the GUI 5. The fuel order form will specify the amount and type of one or more fuels to be delivered together with the requested delivery date. Some information on the fuel order form will be automatically added by the fuel storage tank inventory management system 1, and the information on the fuel order form may be edited by the user if desired.

In one embodiment the fuel order form is automatically filled in to request a fuel delivery on the day corresponding to the status form being displayed when the order button 212 is selected. If this day is not sufficiently far in the future for a delivery to be possible, for example for contractual or practical reasons in the site specific characteristics information 12 stored in the data store 3, a warning message may be supplied to the user, and the nearest day when a delivery will be possible is selected as the delivery date instead.

The fuel order form is automatically filled in to request delivery of the fuel or fuels stored in selected storage tanks 102 at the filling station 100 which have a safe window 14 which is equal to or less than the length of delay for fuel deliveries to the filling station 100. The fuel order form is automatically filled in with an amount of each fuel to be ordered based on the predicted amount of the ullage volume for each of the selected fuel storage tanks 102 so that the amount of each fuel ordered is as large as possible, taking into account the maximum size and, where applicable, the cell sizes of the delivery road tanker vehicle, without being larger than the predicted ullage for the corresponding selected fuel storage tank 102. In the event that the total fuel volume of the resulting fuel order is below a required size, for example where it is required to only submit orders corresponding to the maximum capacity of the road tanker delivery vehicle, amounts of further fuels may be added to the order form for a further fuel or fuels in order of the length of the safe windows of the corresponding fuel storage tanks 102, starting with the shortest window.

The user can review the fuel order form and edit the information on the fuel order form as desired. When the user is satisfied with the fuel order form the fuel order form is sent to the fuel supplier to instruct the fuel delivery to be made.

In the illustrated embodiment the fuel order form is sent to a fuel supplier by email. In other examples the fuel order form may be automatically linked to a fuel supplier server to submit the fuel order.

In some examples the fuel order form may be displayed to the user by other means than the GUI 5. In some examples the fuel order form may be displayed on the visual display 17 of the fuel storage tank inventory management system 1.

The illustrated example discusses the possibility ordering multiple different fuels together, for example to satisfy requirements for a minimum total order volume. It will be understood that this is mainly applicable to liquid fuels, for example different grades of petrol and diesel fuel, and not to LPG fuel, which generally requires a separate dedicated fuel delivery vehicle to liquid fuels.

As is explained above, the operator is informed of the safe delivery windows for the different fuel storage tanks 102, indicating the final days on which fuel deliveries must be received and the latest days when orders for fuel deliveries to refill the different storage tanks 102 must be made. The predicted amounts of stored fuel and the predicted ullage values for the different fuel storage tanks 102 and the identified ends of the safe delivery windows may be used by the operator as a basis for scheduling fuel deliveries to ensure that the filling station 100 does not run out of stored fuel for supply to customers. The predicted ullage values correspond to the predicted empty volumes of the fuel storage tanks 102, and will indicate the maximum amounts of fuel which could be accepted for delivery to each fuel storage tank 102 on each day. This may allow the holding of unnecessarily high stocks of fuel and unnecessarily frequent restocking to be avoided. Further, the ordering of too much fuel for delivery and the resulting risk of accidental overfilling of a fuel storage tank may be avoided. In some examples the deliveries may be arranged at times which reduce the environmental and financial costs of operating the delivery vehicles, or optimize the routes taken by fuel delivery vehicles.

In the illustrated example the predetermined threshold of the known length of delay for fuel deliveries is 2 days. In other examples a different value may be used, in some examples the threshold may be 3 days.

In the illustrated examples an indicated safe delivery window is highlighted by being displayed in a contrasting color. In other examples different forms of highlighting may be used.

The fuel storage tank inventory management system 1 may also inform the operator through the GUI 5 of any stored site specific characteristics information 12 which may be relevant to the scheduling of a fuel delivery. Some examples of such site specific characteristics information 12 include limits on the maximum size of tanker vehicle which can access tank filling points, and limitations on the times and/or dates when fuel deliveries can be received. Such limitations may be practical in nature, such as times when sufficient trained staff are on duty to receive the delivery, or the amount of prior notice required for a delivery to be made, or alternatively may be legal/contractual in nature, such as agreements or covenants limiting the filling station to particular delivery times. This is not intended to be an exhaustive list and other site specific characteristics are possible.

The fuel storage tank inventory management system 1 may also inform the operator through the GUI 5 when the most recent delivery of fuel was made to the filling station.

Where the limitations on fuel deliveries are practical in nature the operator may take action to change these, such as changing staffing rosters. When the stored site specific characteristics information 12 has been updated to reflect the change, the fuel tank inventory management system 1 may inform the operator through the GUI 5 of the changed stored site specific characteristics information 12. For example, where staffing rosters are changed in a staff scheduling system for the filling station, the staff scheduling system may automatically provide the updated staffing roster to the system 1. In other examples the systems may be integrated so that a change to the staffing roster can be requested using the GUI 5.

In the illustrated example the fuel storage tank inventory management system 1 makes predictions of future fuel demand with a granularity of one day. That is, the fuel tank inventory management system 1 predicts the amount of demand for fuel at the filling station for each day, the resulting predicted amount of fuel remaining in storage at the filling station at the end of each day is determined, and the safe window for a fuel delivery is determined as a number of days within which a fuel delivery must be made. In other examples the predicted amount of fuel remaining in storage at the filling station may be determined at another time of day, if desired. In other examples different time periods and granularities of the predictions of future fuel demand and remaining fuel stores may be used if desired. In some examples a time period and granularity of an hour may be used instead of a day. An hourly granularity may, for example, be useful in filling stations having very high sales volumes where one or more deliveries of fuel may be required daily.

In some examples a user may be able to select the granularity used by the fuel storage tank inventory management system 1. In some examples the user may be able to switch between the calculation and display of data at a granularity a day and a granularity of an hour, for example by toggling from one granularity to the other.

In some examples, when a safe window length value 203 of zero would be indicated in the current status screen 200, indicating that the fuel in the corresponding fuel storage tank 102 will run out today, a prediction with finer granularity may be made in order to provide an indication to a user how much time remains before the fuel in the tank runs out. For example, a safe window length value expressed as a fraction of a day, or expressed in hours may be given instead of a value of zero days.

In the illustrated example the display of the different status screens is controlled by selectin different buttons 211a to 211g in the button bar 211. In other examples a slider may be used to control which of the different status screens is displayed.

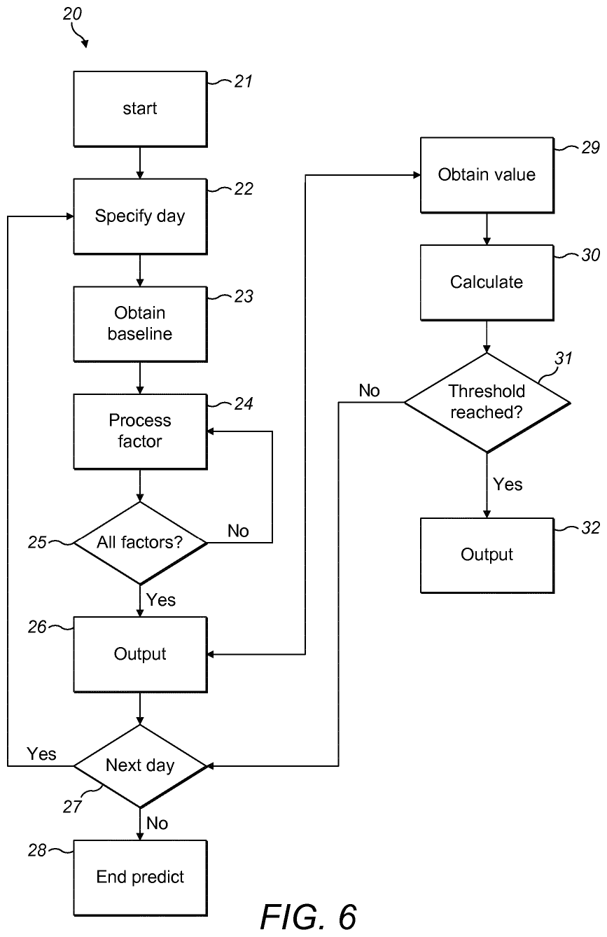

FIG. 6 illustrates a flow chart of a method 20 of predicting fuel stocks which may be used in the illustrated fuel stock prediction system 4. The illustrated method 20 relates to a method of predicting the stock of a single fuel, that is a single fuel type and grade combination, in a single fuel storage tank.

The illustrated method 20 starts, in block 21, to generate a prediction of future fuel stock values for a specific single fuel storage tank at the filling station. In general the system 4 will be operating continuously so that the predictions are continuously updated as new data becomes available, to provide a real time, or near real time prediction.

In other examples the fuel storage tank inventory management system 1 may only make a prediction in response to an instruction, such an instruction may for example be input by an operator of the fuel storage tank inventory management system 1.

The system controller 6 instructs the prediction engine 2 to generate a prediction of future fuel demand for a first specific day of interest in the particular period of time in block 22. In the example the first specific day considered will be the current day, or the following day if the filling station has closed for the night, but this is not essential.

The prediction engine 2 recovers from the data store 3 an appropriate baseline value for fuel demand from the specific fuel storage tank on the specific day in block 23. The data store 3 includes baseline values of fuel demand for each day of the week derived from analysis of historical data. For example, the baseline fuel demand value for a Wednesday may be the average fuel demand averaged over all Wednesdays in available historical data. The data store may include different baseline fuel demand values to be used if the specified day is one when that day of the week is a public holiday. These baseline fuel demand values may conveniently be stored in the data store 3 in the form of tables.

The prediction engine 2 then alters the baseline fuel demand value for the day based on the received information inputs 7 regarding the factors which may affect fuel demand at the filling station which are stored in the data store 3 for that day. The prediction engine 2 processes the stored information input 7 associated with each factor for the day under consideration in order. The relevant information inputs 7 may, for example, include notifications of relevant events taking place on that day and/or values of relevant parameters for that day. In practice, the information inputs 7 will generally have be received asynchronously at different times and stored in the data store 3 together with an indication which day or days each of the stored information inputs 7 applies to under the control of the controller 6.

The prediction engine 2 obtains and processes a stored information input 7 relating to a first factor and an associated algorithm from the data store 3, in block 24. The algorithm indicates how the factor affects fuel demand, and specifically how the value of the associated stored information input 7 for the factor affects fuel demand. The prediction engine 2 then processes the obtained information input 7 by executing the associated algorithm using the associated stored information input value 7 to determine how much the baseline demand value should be adjusted upwards or downwards based upon the factor, and adjusts the demand value accordingly to provide an adjusted demand value.

The prediction engine 2 then determines in block 25 whether the stored information inputs 7 have been processed for all factors. If not, the prediction engine returns to block 24 and repeats the obtaining and processing for the stored information input 7 relating to the next factor.

When the prediction engine 2 determines in block 25 that the stored information inputs 7 have been processed for all factors, the prediction engine outputs a final adjusted demand value based on all of the factors to the fuel stock predictor 4 in block 26. This final adjusted demand value is the predicted value of future fuel demand 9 for the specific fuel storage tank on the day of interest.

The prediction engine 2 then waits at block 27 to be informed whether a prediction of future fuel demand for a next specific day of interest is required.

The final adjusted demand value output by the prediction engine 2 in block 26 providing the predicted value of future fuel demand 9 for the day of interest is supplied to the fuel stock predictor 4.

The fuel stock predictor 4 obtains the predicted value of future fuel demand 9 for the day of interest from the prediction engine 2 and obtains a stored fuel stock value 11 of the amount of fuel stored in the specific fuel storage tank at the filling station at the start of the day of interest from the data store 3, in block 29.

The fuel stock predictor 4 subtracts the predicted value of future fuel demand 9 for the day of interest from the fuel stock value at the start of the day of interest to determine a predicted amount of fuel stored at the filling station at the end of the day of interest in block 30.

In some examples, where the day of interest is the current day the fuel stock predictor 4 may in block 29, instead obtain the predicted value of future fuel demand 9 for the current day of interest from the prediction engine 2, and use this to determine a predicted value of fuel demand for the remainder of the day. In one example the predicted value of fuel demand for the remainder of the day may be based on the proportion of the day remaining. The fuel stock predictor 4 may also obtain a stored fuel stock value 11 of the amount of fuel currently stored at the filling station from the data store 3. The fuel stock predictor 4 may then use these to determine a predicted amount of fuel stored at the filling station at the end of the current day of interest, or at any other future time of day of interest, in block 30.

The predicted amount of fuel stored at the filling station at the end of the day of interest is stored in the data store 3, and is output to the window determining unit 16.

It will be understood that if the day of interest is the current day, or the following day if the filling station has closed for the night, the fuel stock value at the start of the day of interest will be the stored fuel information 8. If the day of interest is a subsequent day the fuel stock value at the start of the day of interest will be a stored predicted value.

The window determining unit 16 obtains the predicted amount of fuel stored at the filling station at the end of the day of interest from the fuel stock predictor 4 and compares this to a threshold fuel reserve amount in block 31. The threshold reserve amount is a predetermined positive value in order to prevent the amount of fuel in the tank being fully depleted, and to prevent the amount of fuel in the tank being depleted below a minimum safe value. Generally, impurities, such as dirt, tend to accumulate in the bottoms of fuel storage tanks over time so that it is generally preferred not to deplete the amount of fuel in the tank below a predetermined level in order to avoid providing contaminated or dirty fuel to customers. In the illustrated example the effective tank capacity 205 is calculated by taking away the unusable tank capacity from the actual absolute tank capacity.

In some examples the fuel storage tank may have a low fuel level sensor and alarm in order to provide a warning that the amount of stored fuel has reached, or dropped below, a predetermined minimum value so that the supply of fuel from the tank can be stopped to avoid providing contaminated or dirty fuel to customers. In such examples the threshold reserve amount may conveniently be set to be the same as, or slightly above, this minimum value so that the fuel in the tank is not depleted to a level where the low fuel level sensor and alarm are activated.

In some examples the threshold may be derived from the predicted value of future fuel demand for that day, for example as a fraction or percentage of predicted daily demand. In some examples the threshold fuel reserve amount may be zero.

If the predicted amount of fuel is determined in block 31 to be above the threshold the window determining unit 16 informs the prediction engine 2 that a prediction of future fuel demand for a next specific day of interest is required.

The prediction engine 2 responds to this by leaving block 27, and returns to block 22 and generates a prediction of future fuel demand for a next specific day of interest, so that the prediction engine 2 repeats the method of blocks 22 to 27 for the next day, including outputting a final adjusted demand value for the next specific day of interest to the fuel stock predictor 4 in block 26. The fuel stock predictor 4 repeats steps 29 and 30 for the final adjusted demand value for the next day of interest to determine a predicted amount of fuel stored in the specific fuel storage tank at the filling station at the end of the next day of interest. The window determining unit 16 obtains the predicted amount of fuel stored at the filling station at the end of the next day of interest from the fuel stock predictor 4 and compares this to the threshold fuel reserve amount in block 31.

Accordingly, steps 22 to 31 are repeated so long as the predicted amount of fuel stored in the specific fuel storage tank at the filling station at the end of each successive next day is above the threshold. Although periods of a day are shown by way of example, other regular or irregular time periods for the prediction of the amount of fuel stored at the end of a time period may be used.

If the predicted amount of fuel is determined in block 31 to be below the threshold the window determining unit 16 informs the prediction engine 2 that no prediction of future fuel demand for a next specific day of interest is required. The prediction engine 2 responds to this by leaving block 27, and ending the prediction sequence in block 28.

If the predicted amount of fuel is determined to be below the threshold in block 31 the window determining unit 16 determines that the day before the specific day of interest for which this prediction has been made is the final day of a safe fuel delivery window for the specific fuel storage tank, and that a fuel delivery for the specific fuel storage tank must be received before the end of that day before the specific day of interest. In some alternative examples the window determining unit 16 may determine that a fuel delivery for the specific fuel storage tank must be received before the end of the day predicted to have a value below the threshold rather than the end of the day preceding that day.

The fuel tank inventory management system 1 provides the final day of the safe delivery window and the predicted amount of fuel stored in the specific fuel storage tank at the filling station at the end of each day within the safe delivery window to the operator through the GUI 5, in block 32. This information is available through the status screens of the GUI 5, as discussed above.

The illustrated example of a method 20 of predicting fuel stocks illustrated in FIG. 6 predicts the stock level of a single fuel, that is a fuel of a single fuel type and fuel grade in a single storage tank 102 at the filling station 100. The fuel stock prediction system 1 will generally repeat the method 20 for each of the different fuel storage tanks 102 at the filling station 100 so that the fuel stock levels of the different fuel types and grades in the different tanks may all be predicted and controlled.

In some examples where the fuel storage tank inventory management system 1 is located at a filling station 100 selling a specific fuel, that is a specific fuel type and fuel grade combination, stored in multiple storage tanks, the stored site specific characteristic data may include the relative rate at which the total amount of that fuel sold is taken from different ones of the storage tanks. This may allow a single fuel stock prediction produced by the method 20 to be used to predict the amount of that fuel sold from each one of the storage tanks at the filling station 100 storing that fuel, which may reduce the amount of computation required.

Where the fuel storage tank inventory management system 1 is located at a filling station selling multiple different fuels stored in multiple storage tanks the stored site specific characteristic data may include the connection and correlation between the demands for, and rates of tank depletion of, the different fuels. These site specific characteristics may be determined from historical data by suitable data analysis. Knowing these site specific characteristic may simplify and make more accurate any aggregation of different fuels, grades and/or tanks in the fuel storage tank inventory management system. In some examples, these site specific characteristics may be used to allow a single fuel stock prediction produced by the method 20 to be used to predict the amount of each fuel sold from the storage tanks at the filling station 100, which may reduce the amount of computation required.

In the illustrated example the current status screen 200 displays the current status of the stocks of fuel in the different storage tanks 102 at the filling station 100, and in particular displays the current fuel amount value 204 and tank ullage value 206 of each fuel storage tank 102 at the filling station 100. In other examples the current status screen 200 may displays the predicted status of the stocks of fuel in the different storage tanks 102 at the filling station 100 at the end of the current day, and in particular may display the predicted fuel amount value 204 and tank ullage value 206 of each fuel storage tank 102 at the filling station 100 at the end of the current day.

In some examples the fuel storage tank inventory management system 1 may be switchable between displaying the current values and the predicted values for the end of the current day in the current status screen. This may, for example, be switchable by the operator, so that the operator can view the values which they find most useful.

In the illustrated example the GUI 5 can display a current status screen and future status screens for the following six days, providing a week long status view with a six day “look ahead” time which the user can move backwards and forwards through by appropriate screen selection. In other examples a different number of future status screens may be available, allowing a longer or shorter look ahead time.

In the illustrated example the status screens of the GUI 5 display the fuel amount value 204 and tank ullage value 206 of each fuel storage tank 102 at the filling station 100 at different times. In other examples the fuel amount value only of each fuel storage tank 102 may be displayed. In other examples the ullage value, that is the empty volume, only of each fuel storage tank 102 may be displayed.

In some examples the fuel storage tank inventory management system 1 may automatically request a fuel delivery for the fuel in a storage tank from a fuel supplier before the end of the safe delivery window for that storage tank. In some examples the fuel storage tank inventory management system 1 may only automatically request a fuel delivery for the fuel in a storage tank from a fuel supplier before the end of the safe delivery window for that storage tank if the storage tank is the only storage tank for that fuel at the filling station, or all other storage tanks for that fuel at the filling station are already empty.

In some examples the fuel tank inventory management system 1 may not be used to request and schedule fuel deliveries and the operator must request and schedule a fuel delivery based on the information provided by the fuel storage tank inventory management system 1 using other means.

The example described above relates to a fuel tank inventory management system for multiple different fuels, that is different types and grades of fuel, stored in multiple different tanks, and to determine safe delivery windows for each of the different tanks. In other examples the fuel tank inventory management system may determine a safe delivery window for each fuel, but not for different tanks containing the same fuel.

The fuel tank inventory management system may be configured to aggregate data across the fuel types, grades and tanks, so as to predict the optimal window for refilling all of the storage tanks at the filling station, or for refilling some or one of the storage tanks containing one or some of the fuel types or grades stored at the filling station. Such aggregation may include aggregation by volume, available stocks, price, or a weighted combination thereof.

The example described above relates to a fuel tank inventory management system for multiple different fuels, that is different types and grades of fuel, stored in multiple different tanks, in other simpler examples the fuel tank inventory management system may be for a single fuel stored in a single tank or multiple tanks.

If the location of the filling station is such that demand for fuel is affected by a scheduled public event the prediction engine 2 may take into account whether such an event is scheduled to occur or not on a day of interest. For example, if the filling station is near a racetrack or sport stadium the predicted demand for fuel may be significantly different on race or match days than on other days. In some examples this may be done by using a different baseline value for event days and non-event days. In other examples this may be done by selectively adjusting the demand value based on whether a corresponding stored information input indicates and event day or a non-event day.

In the illustrated embodiment, one factor affecting the fuel demand at a filling station which is taken into account by the prediction engine 2 is the price at which the fuel is offered for sale at that filling station. Unlike most other factors which may affect the fuel demand at the filling station this sale price is under the control of the operator of the filling station. This price is commonly referred to as the pole sign price, because this is generally prominently displayed at the filling station, usually on a sign mounted on a pole.

In the illustrated embodiment, one factor taken into account by the prediction engine 2 is the relative price or prices at which fuel is offered for sale at the filling station compared to the price or prices of other nearby filling stations located locally to the filling station. A nearby filling station may be regarded as located locally to the filling station if the two filling stations compete for the same business or customers. The fuel demand at a filling station may be affected by the relative prices of fuel at that filling station and at the other nearby filling stations located locally to that filling station. In one example nearby filling stations may be defined as being located locally if they are within 5 km of the filling station. In other examples different distances or criteria may be used, which may be influenced by local geography, such as the denseness of the local road network.

In the illustrated embodiment the prediction engine 2 is provided with the fuel price at the filling station automatically by the filling station point of sale system. In other examples this fuel price may be provided by other parts of the filling station equipment. In some examples the operator can input this fuel price into the fuel stock prediction system, for example by using the user interface 5.

Price data regarding other local filling stations may be one of the information inputs 7 to the fuel storage tank inventory management system 1.

The prediction engine 2 of the fuel storage tank inventory management system 1 may use the price at which fuel is offered for sale at the filling station and the price data regarding other local filling stations as one factor affecting fuel demand at the filling station. Since the price data can be up to date real time data this allows the fuel demand and fuel stock to be accurately predicted.

In the illustrated example the user can input a proposed fuel price change into the fuel storage tank inventory management system, together with the proposed timing of the fuel price change, for example by using the GUI 5. The fuel storage tank inventory management system 1 can then generate a prediction of future fuel demand, fuel stocks and safe delivery windows if the proposed fuel price change is carried out, and present these predictions to the operator by display of the different status screens. This feature can be used to determine the effect of proposed fuel price changes on future fuel demand, fuel stocks and safe delivery windows, and to determine what effect the proposed fuel price change will have on fuel delivery requirements and/or schedules. This feature can be used to inform and assist decision making in deciding whether or not to make the proposed changes. In some examples this feature could be extended to include a number of proposed fuel price changes at different times.

If the user decides that the proposed price change is to be executed the user can confirm this to the fuel storage tank inventory management system 1, for example by using the GUI 5, so that the fuel storage tank inventory management system 1 can take the price change into account in future predictions. The user or operator must then manually input the price change into the filling station systems, such as the site controller, at the appropriate time so that the new price can be charged to customers and any signs can be updated to display the new price. In some examples the price change may be automatically notified to the filling station.

If the user or operator, or the fuel storage tank inventory management system 1, implements a price change for any or every fuel (that is, type and grade of fuel), the user or operator or the system using the software or firmware will also change the display in the fuel pump or pumps and price sign, signs, pole or poles associated with that fuel as a visible manifestation of the changes resulting from the change in selling price of the fuel, and on any electronic point of sale systems and displays.

In the illustrated examples, if the user becomes aware that a local filling station intends to change its fuel price in the future, the user can input the proposed fuel price change and its expected timing into the fuel storage tank inventory management system, for example by using the GUI 5. The fuel storage tank inventory management system can then generate a prediction of future fuel demand and fuel stocks taking the intended fuel price change into account. In some examples this feature could be extended to include a number of proposed fuel price changes at different times. The filling station operator or user may become aware of an intended future price change at a local filling station through publicity or advertising of the planned price reduction, for example through local poster, press or social media.

In the illustrated example the baseline fuel demands for each day stored in the information store 3 may be derived from recorded historic data by data analysis techniques.

In the illustrated example the factors stored in the information store 3 may be derived from recorded historic data by data analysis techniques.

The baseline fuel demands and factors may be derived from historic fuel demand data specific to the filling station. They may also be based on general historic fuel demand data. In some examples a fuel storage tank inventory management system 1 newly installed at a filling station may start using generic factors and modify these factors over time based on fuel demand data specific to the filling station as this data is accumulated.

As is explained above, in the illustrated examples one of the factors taken into account by the prediction engine 2 is the price or prices at which fuel is offered for sale at the filling station and other nearby filling stations. Other factors may also be taken into account.

One factor which may be taken into account is predicted amounts of road traffic. This may be the general amount of road traffic across the entire country or region, which may be obtained from a government website, or from commercial and motoring organizations offering traffic management services. Alternatively, or additionally, this may be or the amount of road traffic expected on the specific roads close to, and served by, the filling station, which may be obtained from a government website, or from commercial and motoring organizations offering traffic management services. This allows for local management of fuel pricing information based on traffic density.

Another factor which may be taken into account is school holidays. Information regarding the dates of school holidays may be obtained from a government, school authority, or school website.

Another factor which may be taken into account is predicted roadworks. Information regarding roadworks may be obtained from a government website, or from commercial and motoring organizations offering traffic management services.

Another factor which may be taken into account is national and/or regional average fuel prices. In this case both the absolute value of average fuel prices and any difference between the average value and the fuel price at the filling station may be taken into account. Information regarding average fuel prices may be obtained from motoring organization websites. Further, average fuel prices may be calculated by the central fuel price collector in examples where this is used.

Another factor which may be taken into account is weather. Information regarding predicted weather may be obtained from a government website, or from commercial forecasting agencies.

The possible factors and information sources set out above are provided as examples only, and are not intended to be exhaustive.

If the filling station is co-located with a retail store, such as a supermarket, another factor which may be taken into account is the number of customers expected to visit the retail store. The retail store may be able to provide predictions of customer numbers based on past performance in previous years on the same day, or a corresponding, day, any planned promotional events at the retail store, or anticipated promotional events at rival stores.

As is explained above, In the illustrated example the operator can input a proposed fuel price change into the fuel storage tank inventory management system, together with the proposed timing of the fuel price change, use this to determine the effect of proposed fuel price changes on future fuel demand and fuel stocks, and to determine what effect the proposed fuel price change will have on fuel delivery requirements and/or schedules. If it is intended to publicize the proposed fuel price change, for example if it is a price reduction, a further factor which may be taken into account is the scale and duration of the publicity. For example, what communication channels are used, the number and size of the publicity materials, and the duration.

The price change in the fuel is automatically or manually entered into the fuel pole signs and the pump price indicators as a visual display. Any actual change in the price of any fuel or grade of fuel will be expected to affect the rate at which the or each storage tank for that fuel is depleted, and such price change is therefore fed into the predictor 2, and its effects on demand predicted by the predictor 2.

In some examples the fuel storage tank inventory management system 1 receives fuel cost data identifying whether the cost of fuel for supply to the filling station is currently rising or falling as one of the information inputs 7. In one example this cost data is sent periodically. In such examples, the fuel cost data identifying whether the cost of fuel for supply to the filling station is currently rising or falling may be displayed to the operator by the GUI 5, for example on the status screens.

The stored site specific characteristic data may include fuel cost data specific to the filling station, for example any site specific delivery costs additional to the general market fuel cost, such as the wholesale fuel spot price.

As discussed above, the fuel storage tank inventory management system 1 provides the operator with available safe windows for receiving fuel deliveries, so that fuel deliveries can be arranged at advantageous times within these windows. In the examples described above the fuel storage tank inventory management system 1 may also inform the operator whether the cost of fuel for supply to the filling station is currently rising or falling, enabling this fact to be taken into account when scheduling the fuel delivery.

In general, the price paid for fuel by a filling station is the market price at the time of delivery, or is based upon this market price. Accordingly, appropriate scheduling of a fuel delivery may allow the cost to be minimized, potentially increasing the filling station profit margins. In general it will be advantageous to schedule fuel deliveries as soon as possible when prices are rising, and to delay fuel deliveries within the identified available safe windows when prices are falling, subject normally to not delaying the delivery and replenishment of the storage tank or tanks for so long that the storage tank(s) are emptied and the associated pumps at the filling station shut down. Any delay in the scheduled fuel deliveries may also be subject to constraints set out in the stored site specific characteristics. In some examples the information automatically filled in on the fuel order form may be selected taking this into account.

In many cases filling stations are contractually required to source their fuel from a specific supplier. Further, even when this is not the case, some suppliers may only supply filling stations in a specific geographical area. Accordingly, the fuel storage tank inventory management system 1 may only receive fuel cost data relating to a fuel supplier or suppliers from which the filling station is able to order fuel.

In some examples the system 1 may be arranged to calculate the profit margin at a current sale price of each fuel, or at a proposed future sale price, and provide this profit margin information together with the current, or proposed, sale price of the fuel to the operator. The profit margin and sale price information may, for example be displayed by the GUI 5 on, or together with, the status screens described above, or on separate screens. The profit margin may for example be expressed as a monetary value per liter of a fuel sold.

The profit margin may be calculated upon a blended or average cost value of the stored fuel in each fuel storage tank. These cost values may be calculated by the system 1 based on information regarding the amounts and costs of delivered fuel which has been added to the tank in the past stored in the data store 3. In some examples where there are multiple tanks containing the same fuel at a filling station the profit margin may be based on a blended or average cost for all of the stored fuel of that type in all of the fuel storage tanks at the filling station. In some examples the profit margin figures may be calculated taking into account the effect on profit margins of fuel sales made using payment cards or fuel cards in which a part of the payment is retained by the card issuer or operator.

In some examples the system 1 may calculate other performance figures and provide these to the operator. These performance figures may, for example be displayed by the GUI 5 on, or together with, the status screens described above, or on separate screens. Examples of performance figures may include volumes of fuel sold, total sales and/or total profit over specified periods, for example daily. Other performance figures and periods may be selected. The system 1 is able to provide these performance figures in real; time, or close to real time.

In some examples the system 1 may display targets to the operator together with the profit margin, or other performance figures. These targets and performance figures may, for example be displayed by the GUI 5 on, or together with, the status screens described above, or on separate screens.

In some examples the system 1 may generate reports based upon the performance figures and/or targets and send the reports to the operator and/or other interested parties. Such reports may provide insights into activity at the filling station. For example, the reports may identify times when sales at the filling station are unusually high or unusually low. This may be taken into account when scheduling fuel deliveries to the filling station, in most cases it will be desirable to schedule fuel deliveries for times when the filling station is less busy in order to minimize inconvenience and disruption to customers.

In some examples the system 1 may analyze the information inputs 7 and generate an alert in response to predetermined events. For example an alert may be generated if a pump or point of sale equipment, such as a till, is not working, if fuel is being sold at the wrong price, or if sales data such as timestamps are incorrect or inconsistent. Other alert conditions may be defined as desired. Such alerts may be provided to an operator through the GUI 5, or other means. Alerts may also be provided to management or oversight personnel at locations remote from the filling station.

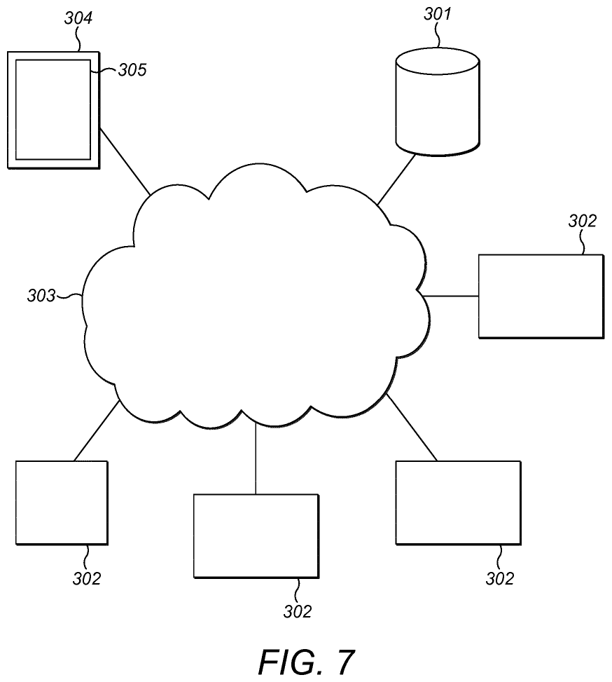

FIG. 7 illustrates a system for carrying out fuel inventory management at a plurality of filling stations.

In FIG. 7, according to a second embodiment of the invention a fuel inventory management system 300 comprises a central fuel tank inventory management element 301 connected to a number of different filling stations 302 through a communications network 303. The central fuel tank inventory management element 301 comprises a fuel demand prediction engine, a data store, and a fuel stock predictor providing corresponding functionality to the fuel demand prediction engine 2, data store 3, and fuel stock predictor 4 of the fuel storage tank inventory management system 1 according to the first embodiment. The central fuel tank inventory management element 301 is also connected to a communications device 304 through the communications network 303.

FIG. 7 shows only four filling stations 302, but in practice there may be any number of filling stations 302 in the fuel inventory management system 300, and possibly a large number.

The communications network 302 may be a public communications network, such as the internet. The central fuel tank inventory management element 301 may be arranged to operate as a server.

In operation, the central fuel tank inventory management element 301 receives information regarding fuel sales and stored fuel volumes from electronic systems at the filling stations 302. The central fuel tank inventory management element 301 then makes predictions of future fuel demand for the different filling stations 302, and determines future stored fuel amounts and safe fuel delivery windows for the different fuel storage tanks of the different filling stations 302, in a similar manner to the fuel storage tank inventory management system 1 according to the first embodiment. The results of these predictions and determinations are then stored in the central fuel tank inventory management element 301.

The communications device 304 is used by an operator to access and display the results of the predictions and determinations regarding the different filling stations 302 which are stored in the central fuel tank inventory management element 301. The communications device 304 acts as a remote user interface to the central fuel tank inventory management element 301 and comprises a GUI 305 similar to the GUI 5 according to the first embodiment, and presenting similar information regarding the different filling stations 302. This information may be presented using status screens similar to those of the first embodiment. In some examples the GUI 305 may display a separate set of status screens for each of the filling stations 304 based on a selection input by the user or operator.

In the illustrated example of FIG. 7 the central fuel tank inventory management element 301 may also generate reports and/or alerts relating to the filling stations 302 in a similar manner to the reports and alerts discussed above with reference to the first embodiment. These reports and/or alerts may be displayed to an operator through the GUI 305, or other means.

An operator can use the information presented on the GUI 305 to schedule and request one or more fuel deliveries of desired amounts of different fuels to the different filling stations 302 within the safe delivery windows of the different fuel storage tanks at the filling stations 302.

The central fuel tank inventory management element 301 is central in the sense that it is a central part of the functionality of the system. The term central does not imply anything regarding the physical or geographical location of the different parts of the system.

In the examples described above a prediction engine is described. Other types of prediction engine may be used.

In the examples described above the stored information inputs for each factor affecting fuel demand are processed in order. This may be a predetermined order.

In the examples described above the prediction engine determines a baseline value for fuel consumption, and then alters this value based on the stored information inputs for each factor affecting fuel demand. In other examples different prediction techniques may be used. In some examples the stored information inputs for multiple factors may be processed to generate an overall alteration value, which is then applied to the baseline value. In some examples the fuel consumption may be derived directly from the stored information inputs using known techniques for making predictions based on comparisons between different datasets. In some examples the prediction engine may be a neural network trained using historical data.

While the examples above have been primarily described with reference to a filling station having multiple types and grades of fuel in which the predictions across types and grades of fuels are made separately, in other examples these types and grades of fuel may be aggregated so as to produce a single prediction across some or all such types and grades of fuel.

In the examples of the first embodiment described above the fuel storage tank inventory management system is located at the filling station. In other examples all, or part, of the fuel storage tank inventory management system may be located remotely from the filling station. In some examples all, or part, of the fuel storage tank inventory management system may be provided by a remote server. In some examples the all, or part, of the fuel storage tank inventory management system may be cloud based.

In the examples described above a single fuel storage tank inventory management system predicts future consumption and stored fuel amounts for multiple different fuels stored in multiple different tanks. In some examples this may be done using a separate dedicated fuel storage tank inventory management system for each unique combination of fuel and tank. In examples where multiple separate fuel storage tank inventory management systems are used these may be provided by different instances of fuel storage tank inventory management system software running on a single set of hardware.

Where the fuel storage tank inventory management system is located at a filling station selling a specific fuel and grade stored in multiple storage tanks the stored site specific characteristic data may include the relative rate at which the total amount of that fuel and grade sold is taken from different ones of the storage tanks. Where the fuel storage tank inventory management system is located at a filling station selling multiple different fuel types and grades stored in multiple storage tanks the stored site specific characteristic data may include the connection and correlation between the demands for, and rates of tank depletion of, the different fuels and/or grades. These site specific characteristics may be determined form historical data by suitable data analysis. Knowing these site specific characteristic may simplify and make more accurate any aggregation of different fuels, grades and/or tanks in the fuel storage tank inventory management system.

In the examples described above the predictions of fuel demand and fuel stock levels are generated in time sequence over a period of time. It is not essential that the predictions of fuel demand for different times, such as different days, are carried out in any particular sequence. However, in order to predict fuel stock levels it is necessary to compare the predictions of fuel demand to the stored fuel amount sequentially in order to correctly predict the remaining fuel stock values.

In the examples described above the predictions of fuel demand and fuel stock levels start from the current time. In some examples further predictions could be made starting from future times. For example, further predictions could be made starting from the scheduled time of a next fuel delivery in order to schedule a future fuel delivery.

The examples described above relate to a retail filling station situation, and in particular to the effect on demand of fuel prices in a retail situation. It should be understood that the fuel prices will still affect demand even if the filing station supplies some fuel to customers who are required to use the filling station, for example fleet vehicles under a supply contract.

The examples described above predict fuel demand and fuel stock levels on a daily basis. In other examples different time periods may be used.

The examples described above indicate the safe window length value for each tank of a number of days. In some examples this value may be shown differently depending on the remaining number of days. For example, numbers below a certain value may be displayed in a different color to those above, or may be shown as flashing. In one example, values of 3 days or less may be displayed in red, while higher values are displayed in a different color, for example green or blue.

The examples described above refer to fuel amounts in liters. In other examples different fuel measurement units may be used.

In the examples described above the user interface may be used to provide further information and messages in addition to those described to the user/operator.

Examples of the invention described above are described as using a single communications network. In other examples the invention may be carried out in situations involving any number of communications networks.

In the examples of the second embodiment described above the central fuel tank inventory management element comprises a server. In some examples the functionality of this element may be provided by a network of servers.

In the example described above an operator at the filling station is referred to. This may be a single operator or a number of different operators.

In the described examples the components may be hardware components or logical components such as software modules or elements.

The examples described above relate to predicting amounts of fuels stored at one or more filling stations. In other examples the invention may be used to predict amounts of other locally stored goods where sale volumes are expected to be influenced by local price differentials.

In the described examples of the invention the fuel storage tank inventory management system may be implemented as any form of a computing and/or electronic device.

Such a device may comprise one or more processors which may be microprocessors, controllers or any other suitable type of processors for processing computer executable instructions to control the operation of the device in order to gather and record routing information. In some examples, for example where a system on a chip architecture is used, the processors may include one or more fixed function blocks (also referred to as accelerators) which implement a part of the method in hardware (rather than software or firmware). Platform software comprising an operating system or any other suitable platform software may be provided at the computing-based device to enable application software to be executed on the device.

The computer executable instructions may be provided using any computer-readable media that is accessible by computing based device. Computer-readable media may include, for example, computer storage media such as a memory and communications media. Computer storage media, such as a memory, includes volatile and non-volatile, removable and non-removable media implemented in any method or technology for storage of information such as computer readable instructions, data structures, program modules or other data. Computer storage media includes, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transport mechanism. As defined herein, computer storage media does not include communication media.

Although the fuel storage tank inventory management system is shown as a single device it will be appreciated that this system may be distributed or located remotely and accessed via a network or other communication link (e.g. using a communication interface).

The term ‘computer’ is used herein to refer to any device with processing capability such that it can execute instructions. Those skilled in the art will realize that such processing capabilities are incorporated into many different devices and therefore the term ‘computer’ includes PCs, servers, mobile telephones, personal digital assistants and many other devices.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

Any range or value given herein may be extended or altered without losing the effect sought, as will be apparent to the skilled person.

It will be understood that the benefits and advantages described above may relate to one embodiment or may relate to several embodiments. The embodiments are not limited to those that solve any or all of the stated problems or those that have any or all of the stated benefits and advantages.

Elements of the described embodiments may be exchanged between the different embodiments. Elements described or claimed as being used in one embodiment may alternatively be used in other embodiments.

Any reference to ‘an’ item refers to one or more of those items. The term ‘comprising’ is used herein to mean including the method steps or elements identified, but that such steps or elements do not comprise an exclusive list and a method or apparatus may contain additional steps or elements.

The order of the steps of the methods described herein is exemplary, but the steps may be carried out in any suitable order, or simultaneously where appropriate. Additionally, steps may be added or substituted in, or individual steps may be deleted from any of the methods without departing from the scope of the subject matter described herein. Aspects of any of the examples described above may be combined with aspects of any of the other examples described to form further examples without losing the effect sought.

It will be understood that the above description of a preferred embodiment is given by way of example only and that various modifications may be made by those skilled in the art. Although various embodiments have been described above with a certain degree of particularity, or with reference to one or more individual embodiments, those skilled in the art could make numerous alterations to the disclosed embodiments without departing from the spirit or scope of this invention.

1. A computer implemented system for fuel storage tank inventory management at a filling station, the system comprising:
obtaining means arranged to obtain information regarding the predicted status of a fuel stored in a specific fuel storage tank at a filling station, the obtained information comprising time window information regarding a time window for receiving a delivery of fuel for the fuel storage tank; and
a graphical user interface ‘GUI’ arranged to output the time window, wherein,
the GUI is arranged to display one of a plurality of different screens in response to detection of a selection input by a user, wherein each of the plurality of different screens displays the predicted status of the fuel stored in the fuel storage tank at a respective one of a plurality of different times, and
the displayed status of the fuel stored in the fuel storage tank comprises the remaining length of the time window at the respective one of the plurality of different times.

2. The system according to claim 1, wherein each of the different screens comprises a time selection input means allowing a user to select which one of the plurality of different times is displayed by the GUI.

3. The system according to claim 2, wherein the time selection input means comprises a plurality of buttons, wherein each button selects a respective one of the plurality of different times for display by the GUI.

4. The system according to claim 2, wherein the time selection input means comprises a slider, wherein the slider can be moved to different positions by a user, wherein each different position selects a respective one of the plurality of different times for display by the GUI.

5. The system according to claim 1, wherein each of the different screens comprises an order input means, wherein the system response to selection of the order input means by generating a fuel order for a delivery of fuel, wherein the fuel order requests a delivery of fuel at the one of the plurality of different times corresponding to the screen being displayed by the GUI.

6. The system according to claim 5, wherein the fuel order is presented to the user for editing before being sent to a fuel supplier.

7. The system according to claim 1, wherein:
the obtained information further comprises the current status of the fuel stored in the fuel storage tank at the filling station; and
the GUI is further arranged to display the current or predicted status of the fuel stored in the fuel storage tank at the selected one of the plurality of different times.

8. The system according to claim 1, wherein:
the obtained information further comprises information regarding the amount of the fuel currently stored or predicted to be stored in the fuel storage tank; and
the displayed status of the fuel stored in the fuel storage tank further comprises the amount of the fuel stored in the fuel storage tank at the selected one of the plurality of different times.

9. The system according to claim 1, wherein:
the obtained information further comprises information regarding the current or predicted ullage value of the fuel storage tank; and
the displayed status of the fuel stored in the fuel storage tank further comprises the ullage value of the fuel storage tank at the selected one of the plurality of different times.

10. The system according to claim 1, wherein:
the obtained information further comprises information regarding the capacity of the fuel storage tank; and
the displayed status of the fuel stored in the fuel storage tank further comprises the capacity of the fuel storage tank.

11. The system according to claim 1, wherein:
the obtained information further comprises information regarding the type and/or grade of the fuel stored in the fuel storage tank; and
the displayed status of the fuel stored in the fuel storage tank further comprises the type and/or grade of the fuel.

12. The system according to claim 1, wherein:
the obtained information further comprises information regarding the amount of the fuel currently stored or predicted to be stored in the fuel storage tank and the capacity of the fuel storage tank; and
the displayed status of the fuel stored in the fuel storage tank further comprises a graphical representation of the amount of the fuel stored in the fuel storage tank at the selected one of the plurality of different times relative to the capacity of the fuel storage tank.

13. The system according to claim 1, wherein the GUI is arranged to display the length of the time window in a highlighted manner when the length of the time window is below a predetermined threshold.

14. The system according to claim 13, wherein the GUI is further arranged to display the length of the time window in a highlighted manner when the remaining length of the time window at the respective one of the plurality of different times is below the predetermined threshold.

15. The system according to claim 13, wherein the predetermined threshold corresponds to the length of time between an order being made for a delivery of the fuel to the filling station and the ordered fuel being delivered to the filling station.

16. The system according to claim 1, wherein:
the obtaining means is arranged to obtain information regarding the predicted status of fuels stored in a plurality of different fuel storage tanks at the filling station, the obtained information comprising time window information regarding respective time windows for adding fuel to each of the different fuel storage tanks;
the graphical user interface ‘GUI’ being arranged to output the time windows;
the GUI is arranged to display the predicted status of the fuel stored in each fuel storage tank at a selected one of a plurality of different times in response to detection of a selection input by a user; and
the displayed status of the fuel stored in each fuel storage tank comprises the remaining length of the respective time window at the respective one of the plurality of different times.

17. The system according to claim 1, wherein the obtaining means comprises:
a fuel demand predictor arranged to predict future fuel demand for the or each fuel at the filling station;
a fuel stock means arranged to obtain a current amount of the fuel stored in the or each fuel storage tank at the filling station;
a fuel stock predictor arranged to predict a future amount of the fuel stored in the or each fuel storage tank at the filling station based upon the current amount of the fuel stored in said fuel storage tank and the predicted future fuel demand for said fuel at the at the filling station; and
means arranged to determine a time window for receiving a fuel delivery for the or each fuel storage tank from the predicted future amount of the fuel stored in said fuel storage tank.

18. The system according to claim 17, wherein the means arranged to determine a time window for receiving a fuel delivery for the or each fuel storage tank from the predicted future amount of the fuel stored in said fuel storage tank makes the determination by comparing the predicted future amount of the fuel to a threshold.

19. The system according to claim 1 wherein the plurality of different times are the ends of a series of regular time periods, or are a designated time within each of a series of regular time periods.

20. The system according to claim 19, wherein each regular time period is a day.

21. The system according to claim 19, wherein the plurality of different times are the ends of consecutive days, and wherein the fuel order requests a delivery of fuel during the day corresponding to the screen being displayed by the GUI.

22. The system according to claim 17, wherein the fuel stock means comprises a fuel level sensor arranged to sense the amount of fuel in the or each fuel storage tank and to provide this amount as the current amount of the fuel stored in said storage tank.

23. The system according to claim 17, wherein the GUI is remote from the rest of the system and is connected to the rest of the system through a communications network.

24. The system according to claim 17, wherein:
the obtaining means is arranged to obtain information regarding the predicted status of fuels stored in specific fuel storage tanks at a plurality of filling stations; and
the GUI is arranged to display the predicted status of the fuel stored in the or each fuel storage tank at a selected one of the plurality of filling stations in response to detection of a selection input by a user.

25. A computer implemented system for fuel storage tank inventory management at a filling station, the system comprising:
obtaining means arranged to obtain information regarding the predicted status of fuel stored in one or more fuel storage tanks, the obtained information comprising time window information regarding a time window for receiving a delivery of fuel for the fuel storage tank before the amount of fuel stored in the fuel storage tank is predicted to fall below a predetermined threshold; and
display means arranged to display a time window for receiving a delivery of fuel in response to detection of a selection input by a user, wherein the time window for receiving a delivery of fuel to the fuel storage tank varies in response to the selection input by the user;
and the display means being further arranged to display, in addition to said time window information, a message actuation whereby generation of a message to trigger fuel supply at a displayed time or time window can be triggered from the same display.

26. The system according to claim 25, wherein the selection input by the user selects a present or future time, the display means displays a time window which will apply at the selected time, and the generated message is to trigger fuel supply at the selected time.

27. The system according to claim 25, wherein the display means is a graphical user interface ‘GUI’.

28. A computer implemented method for fuel storage tank inventory management at a filling station, the method comprising:
obtaining information regarding the predicted status of a fuel stored in a specific fuel storage tank at a filling station, the obtained information comprising time window information regarding a time window for receiving a delivery of fuel for the fuel storage tank; and
rendering a graphical user interface ‘GUI’ arranged to output the time window, wherein,
the GUI is arranged to display the predicted status of the fuel stored in the fuel storage tank at a selected one of a plurality of different times in response to detection of a selection input by a user; and
the displayed status of the fuel stored in the fuel storage tank comprises the remaining length of the time window at the respective one of the plurality of different times.

29. The method according to claim 28, wherein each of the different screens comprises a time selection input means allowing a user to select which one of the plurality of different times is displayed by the GUI.

30. The method according to claim 29, wherein the time selection input means comprises a plurality of buttons, wherein each button selects a respective one of the plurality of different times for display by the GUI.

31. The system according to claim 29, wherein the time selection input means comprises a slider, wherein the slider can be moved to different positions by a user, wherein each different position selects a respective one of the plurality of different times for display by the GUI.

32. The system according to claim 28, wherein each of the different screens comprises an order input means, wherein the system response to selection of the order input means by generating a fuel order for a delivery of fuel, wherein the fuel order requests a delivery of fuel at the one of the plurality of different times corresponding to the screen being displayed by the GUI.

33. The system according to claim 32, wherein the fuel order is presented to the user for editing before being sent to a fuel supplier.

34. The method according to claim 28, wherein:
the obtained information further comprises the current status of the fuel stored in the fuel storage tank at the filling station; and
the GUI is further arranged to display the current or predicted status of the fuel stored in the fuel storage tank at the selected one of the plurality of different times.

35. The method according to claim 28, wherein:
the obtained information further comprises information regarding the amount of the fuel currently stored or predicted to be stored in the fuel storage tank; and
the displayed status of the fuel stored in the fuel storage tank further comprises the amount of the fuel stored in the fuel storage tank at the selected one of the plurality of different times.

36. The method according to claim 28, wherein:
the obtained information further comprises information regarding the current or predicted ullage value of the fuel storage tank; and
the displayed status of the fuel stored in the fuel storage tank further comprises the ullage value of the fuel storage tank at the selected one of the plurality of different times.

37. The method according to claim 28, wherein:
the obtained information further comprises information regarding the capacity of the fuel storage tank; and
the displayed status of the fuel stored in the fuel storage tank further comprises the capacity of the fuel storage tank.

38. The method according to claim 28, wherein:
the obtained information further comprises information regarding the type and/or grade of the fuel stored in the fuel storage tank; and
the displayed status of the fuel stored in the fuel storage tank further comprises the type and/or grade of the fuel.

39. The method according to claim 28, wherein:
the obtained information further comprises information regarding the amount of the fuel currently stored or predicted to be stored in the fuel storage tank and the capacity of the fuel storage tank; and
the displayed status of the fuel stored in the fuel storage tank further comprises a graphical representation of the amount of the fuel stored in the fuel storage tank at the selected one of the plurality of different times relative to the capacity of the fuel storage tank.

40. The method according to claim 28, wherein the GUI is arranged to display the length of the time window in a highlighted manner when the length of the time window is below a predetermined threshold.

41. The method according to claim 40, wherein the GUI is further arranged to display the length of the time window in a highlighted manner when the remaining length of the time window at the respective one of the plurality of different times is below the predetermined threshold.

42. The method according to claim 40, wherein the predetermined threshold corresponds to the length of time between an order being made for a delivery of the fuel to the filling station and the ordered fuel being delivered to the filling station.

43. The method according to claim 28, wherein:
the obtaining information comprises obtaining information regarding the predicted status of fuels stored in a plurality of different fuel storage tanks at the filling station, the obtained information comprising time window information regarding respective time windows for adding fuel to each of the different fuel storage tanks;
the rendered graphical user interface ‘GUI’ being arranged to output the time windows;
the GUI is arranged to display the predicted status of the fuel stored in each fuel storage tank at a selected one of a plurality of different times in response to detection of a selection input by a user; and
the displayed status of the fuel stored in each fuel storage tank comprises the remaining length of the respective time window at the respective one of the plurality of different times.

44. The method according to claim 28, wherein the obtaining information comprises:
predicting future fuel demand for the or each fuel at the filling station;
obtaining a current amount of the fuel stored in the or each fuel storage tank at the filling station;
predicting a future amount of the fuel stored in the or each fuel storage tank at the filling station based upon the current amount of the fuel stored in said fuel storage tank and the predicted future fuel demand for said fuel at the filling station; and
determining a time window for receiving a fuel delivery for the or each fuel storage tank from the predicted future amount of the fuel stored in said fuel storage tank.

45. The method according to claim 44, wherein the means arranged to determine a time window for receiving a fuel delivery for the or each fuel storage tank from the predicted future amount of the fuel stored in said fuel storage tank makes the determination by comparing the predicted future amount of the fuel to a threshold.

46. The method according to claim 28; wherein the plurality of different times are the ends of a series of regular time periods, or are a designated time within each of a series of regular time periods.

47. The method according to claim 46, wherein each regular time period is a day.

48. The method according to claim 46, wherein the plurality of different times are the ends of consecutive days, and wherein the fuel order requests a delivery of fuel during the day corresponding to the screen being displayed by the GUI

49. The method according to claim 44, wherein obtaining a current amount of the fuel stored in the or each fuel storage tank at the filling station comprises using a fuel level sensor to sense the amount of fuel in the or each fuel storage tank and providing this amount as the current amount of the fuel stored in said storage tank.

50. The method according to claim 28, wherein the GUI is remote from the rest of the system and is connected to the rest of the system through a communications network.

51. The method according to claim 28, wherein:
the obtaining information comprises obtaining information regarding the predicted status of fuels stored in specific fuel storage tanks at a plurality of filling stations; and
the GUI is arranged to display the predicted status of the fuel stored in the or each fuel storage tank at a selected one of the plurality of filling stations in response to detection of a selection input by a user.

52. A computer implemented method for fuel storage tank inventory management at a filling station, the system comprising:
obtaining information regarding the predicted status of fuel stored in one or more fuel storage tanks, the obtained information comprising time window information regarding a time window for receiving a delivery of fuel for the fuel storage tank before the amount of fuel stored in the fuel storage tank is predicted to fall below a predetermined threshold; and
displaying a time window for receiving a delivery of fuel in response to detection of a selection input by a user, wherein the time window for receiving a delivery of fuel to the fuel storage tank varies in response to the selection input by the user; and the display means displaying, in addition to said time window information, a message actuation whereby generation of a message to trigger fuel supply at a display time or time window can be triggered from the same display.

53. The method according to claim 52, wherein the selection input by the user selects a present or future time, the display means displays a time window which will apply at the selected time, and the generated message is to trigger fuel supply at the selected time.

54. The method according to claim 52, wherein the display means is a graphical user interface ‘GUI’.

55. A computer program comprising a plurality of computer readable instructions arranged such that, when executed on a processor of a computer they cause the computer to carry out the method according to claim 28.
